(19) United States
(12) Patent Application Publication
(10) Pub. No.: US 2017/0044352 A1
(43) Pub. Date: Feb. 16, 2017

(54) PLASTICIZER COMPOSITION WHICH CONTAINS FURAN DERIVATIVES AND TEREPHTHALIC ACID DIALKYL ESTERS

(71) Applicant: BASF SE, Ludwigshafen (DE)

(72) Inventors: Uwe STORZUM, League City, TX (US); Boris BREITSCHEIDEL, Waldsee (DE)

(21) Appl. No.: 15/305,888

(22) PCT Filed: Apr. 22, 2015
(86) PCT No.: PCT/EP2015/058631

§ 371 Date: Oct. 21, 2016

(30) Foreign Application Priority Data
Apr. 24, 2014 (EP) 1416766.8

(51) Int. Cl. C08K 5/1535; C08K 5/12

(52) U.S. Cl. CPC C08K 5/1535; C08K 5/12; C08K 2201/014

(57) ABSTRACT

The invention relates to a plasticizer composition which contains at least one furan derivative and at least one terephthalic acid dialkyl ester, moulding compounds which contain a thermoplastic polymer or an elastomer and said type of plasticizer composition, and to the use of said plasticizer compositions and moulding compounds.

### BACKGROUND TO THE INVENTION

The present invention relates to a plasticizer composition which comprises at least one furan derivative and at least one dialkyl terephthalate, to molding compositions which comprise a thermoplastic polymer or an elastomer and this plasticizer composition, and to the use of these plasticizer compositions and molding compositions.

### PRIOR ART

Desired processing properties or desired performance characteristics are achieved in many plastics by adding what are known as plasticizers in order to render the plastics softer, more flexible and/or more extensible. The addition of plasticizers generally serves to shift the thermoplastic region of plastics to lower temperatures, so as to obtain the desired elastic properties at lower processing temperatures and lower usage temperatures.

Production quantities of polyvinyl chloride (PVC) are among the highest of any plastic. Because this material is versatile, it is nowadays found in a wide variety of products used in everyday life. PVC therefore has very great economic importance. PVC is intrinsically a plastic that is hard and brittle up to about 80° C., and is used in the form of rigid PVC (PVC-U) by adding heat stabilizers and other additives. Flexible PVC (PVC-P) is obtained only by adding suitable plasticizers, and can be used for many applications for which rigid PVC is unsuitable.

Examples of other important thermoplastic polymers in which plasticizers are usually used are polyvinyl butyral (PVB), homo- and copolymers of styrene, polyacrylates, polysulfides, and thermoplastic polyurethanes (PUs).

The suitability of any substance for use as plasticizer for a particular polymer depends substantially on the properties of the polymer to be plasticized. Desirable plasticizers are generally those which have high compatibility with the polymer to be plasticized, give this good thermoplastic properties, and have only low susceptibility to loss by evaporation and/or by exudation (have high permanence).

There are many different compounds marketed for plasticizing PVC and other plastics. Phthalic diesters with alcohols of different chemical structure have in the past often been used as plasticizers because they have good compatibility with PVC and advantageous performance characteristics, examples being diethylhexyl phthalate (DEHP), diisononyl phthalate (DINP) and diisodecyl phthalate (DIDP). Short-chain phthalates, e.g. dibutyl phthalate (DBP), diisobutyl phthalate (DIBP), benzyl butyl phthalate (BBP) or diisoheptyl phthalate (DIHP), are also used as fast fusers, for example in the production of what are known as plastisols. It is also possible to use dibenzoic esters, such as dipropylene glycol dibenzoates, for the same purpose alongside the short-chain phthalates. Phenyl and cresyl esters of alkylsulfonic acids are examples of another class of plasticizers with good gelling properties, and are obtainable with trademark Mesamoll®.

Plastisols initially are a suspension of finely pulverulant plastics in liquid plasticizers. The salvation rate of the polymer in the plasticizer here is very low at ambient temperature. The polymer is noticeably solvated in the plasticizer only on heating to relatively high temperatures. The individual isolated polymer aggregates here swell and fuse to give a three-dimensional high-viscosity gel. This procedure is termed gelling, and begins at a certain minimum temperature which is termed gel point or salvation temperature. The gelling step is not reversible.

Since plastisols take the form of liquids, these are very often used for the coating of a very wide variety of materials, e.g. textiles, glass nonwovens, etc. This coating is very often composed of a plurality of sublayers.

In a procedure often used in the industrial processing of plastisols, a layer of plastisol is therefore applied and then the plastic, in particular PVC, with the plasticizer is subjected to incipient gelling above the salvation temperature, thus producing a solid layer composed of a mixture of gelled, partially gelled, and ungelled polymer particles. The next sublayer is then applied to this incipiently gelled layer, and once the final layer has been applied the entire structure is processed in its entirety to give the fully gelled plastics product by heating to relatively high temperatures.

Another possibility, alongside production of plastisols, is production of dry pulverulant mixtures of plasticizer and polymers. These dry blends, in particular based on PVC, can then be further processed at elevated temperatures for example by extrusion to give pellets, or processed through conventional shaping processes, such as injection molding, extrusion, or calendering, to give the fully gelled plastics product.

Plasticizers with good gelling properties are additionally required because of increasing technical and economical demands on the processing of thermoplastic polymers and elastomers.

In particular in the production and processing of PVC plastisols, for example for producing PVC coatings, it is inter alia desirable to have available, as fast fuser, a plasticizer with low gelling point and low viscosity, these materials being known as fast fusers. High storage stability of the plastisol is moreover also desirable, i.e. the ungelled plastisol is intended to exhibit no, or only a slight, viscosity rise over the course of time at ambient temperature. As far as possible, these properties are intended to be achieved by addition of a suitable plasticizer with rapid-gelling properties, with no need for the use of other viscosity-reducing additives and/or of solvents.

However, fast fusers generally often have unsatisfactory compatibility with the polymer/additive mixtures, and likewise have unsatisfactory permanence. Another known method for establishing the desired plasticizer properties is therefore to use mixtures of plasticizers, e.g. at least one plasticizer which provides good thermoplastic properties but provides relatively poor gelling, in combination with at least one fast fuser.

There is moreover a requirement to replace at least some of the phthalate plasticizers mentioned in the introduction because these are suspected of being hazardous to health. This applies specifically to sensitive application sectors such as toys, packaging for food or drink, and medical items.

The prior art discloses various alternative plasticizers with different properties for a variety of plastics and specifically for PVC.

A plasticizer class that is known from the prior art and that can be used as alternative to phthalates is based on the cyclohexanepolycarboxylic acids described in WO 99/32427. Unlike their unhydrogenated aromatic analogs, these compounds give rise to no toxicological concerns, and can be used even in sensitive application sectors. The corresponding lower alkyl esters generally have rapid-gelling properties.

WO 00/78704 describes selected dialkylcyclohexane-1,3- and 1,4-dicarboxylic esters for the use as plasticizer in synthetic materials.

U.S. Pat. No. 7,973,194 B1 teaches the use of dibenzyl cyclohexane-1,4-dicarboxylate, benzyl butyl cyclohexane-1,4-dicarboxylate, and dibutyl cyclohexane-1,4-dicarboxylate as rapid-gelling plasticizers for PVC.

Another class of plasticizers known from the prior art which may be used as alternatives to phthalates is that of terephthalic esters as described for example in WO 2009/095126.

The esters of 2,5-urandicarboxylic acid (FDCA) are another plasticizer class.

WO 2012/113608 describes C₅-dialkyl esters of 2,5-furandicarboxylic acid and use of these as plasticizers. These short-chain esters are specifically also suitable for producing plastisols.

WO 2012/113609 describes C₇-dialkyl esters of 2,5-furandicarboxylic acid and use of these as plasticizers.

WO 2011/023490 describes C₉-dialkyl esters of 2,5-furandicarboxylic acid and use of these as plasticizers.

WO 2011/023491 describes C₁₀-dialkyl esters of 2,5-furandicarboxylic acid and use of these as plasticizers.

R. D. Sanderson et al. (J. Appl. Pol. Sci., 1994, vol. 53, 1785-1793) describe the synthesis of esters of 2,5-furandicarboxylic acid and use of these as plasticizers for plastics, in particular polyvinyl chloride (PVC), polyvinyl butyral (PVB), polylactic acid (PLA), polyhydroxybutyric acid (PHB) or polyalkyl methacrylate (PAMA). Specifically, the di(2-ethylhexyl), di(2-octyl), dihexyl, and dibutyl esters of 2,5-furandicarboxylic acid are described, and the plasticizing properties of these are characterized by way of dynamic mechanical thermal analyses.

WO 2012/026861 describes tetraesters of pentaerythritol with monocarboxylic acids and a composition containing a tetraester of pentaerythritol and di(2-ethylhexyl) 2,5-furandicarboxylate as plasticizer for PVC.

It is an object of the present invention to provide a toxicologically acceptable plasticizer composition for thermoplastic polymers and elastomers which on the one hand provides good thermoplastic properties and on the other hand provides good gelling properties, i.e. low gel point. The plasticizer composition is intended thus to have particular suitability for providing plastisols. The plasticizer composition is intended to have high compatibility with the polymer to be plasticized, and thus to have no, or only slight, tendency toward exudation during use, with the result that the resilient properties of the plasticized plastics produced using these plasticizers are retained for prolonged periods.

Surprisingly, said object is achieved via a plasticizer composition comprising

a) at least one compound of the general formula (I),

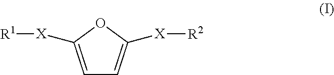

in which
X is *—(C═O)—O—, *—(CH₂)ₙ—O—, or *—(CH₂)ₙ—O—(C═O)—, where * represents the point of linkage to the furan ring, and n has the value 0, 1, or 2;
and
R¹ and R² are mutually independently an unbranched or branched C₈-alkyl moiety,

b) at least one compound of the general formula (II),

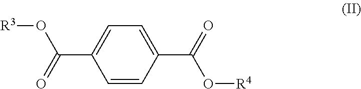

in which
R³ and R⁴ are selected mutually independently from branched and unbranched C₄-C₁₂-alkyl moieties.

The invention further provides molding compositions which comprise at least one thermoplastic polymer or elastomer and one plasticizer composition as defined above and hereinafter.

The invention further provides the use of a plasticizer composition as defined above and hereinafter as plasticizer for thermoplastic polymers, in particular polyvinyl chloride (PVC), and elastomers.

The invention further provides the use of a plasticizer composition as defined above and hereinafter as plasticizer in plastisols.

The invention further provides the use of said molding compositions for the production of moldings and foils.

### DESCRIPTION OF THE INVENTION

The plasticizer compositions of the invention have the following advantages:
The plasticizer compositions of the invention feature high compatibility with the polymer to be plasticized, in particular PVC.
The plasticizer compositions of the invention have no, or only slight, tendency toward exudation during use of the final products. As a result, the resilient properties of the plasticized plastics produced using these plasticizer compositions are retained for prolonged periods.
The plasticizer compositions of the invention have advantageous suitability for achieving a wide variety of very different and complex processing properties and usage properties of plastics.
The plasticizer composition of the invention is advantageously suitable for the production of plastisols.
The compounds (I) comprised in the plasticizer composition of the invention have very good suitability as fast fusers by virtue of their extremely low solvation temperatures in accordance with DIN 53408. Even small amounts of the compounds (I) in the plasticizer composition of the invention are sufficient to reduce the temperature required for the gelling of a thermoplastic polymer and/or to increase the gelling rate thereof.
The plasticizer compositions of the invention are suitable for the use for the production of moldings and foils for sensitive application sectors, examples being medical products, packaging for food and drink, products for the interior sector, for example in dwellings and in vehicles; other examples are toys, child-care items, etc.
The compounds (I) comprised in the plasticizer compositions of the invention can be produced by using readily obtainable starting materials. One particular economic and environmental advantage consists in the possibility of utilizing not only petrochemical feedstocks available in large quantities but also renewable raw materials for production of the compounds (I) used in the invention. By way of example, the starting materials for the furan rings are obtainable from naturally occurring carbohydrates such as cellulose and starch, while the alcohols that can be used to introduce the pendant chains are available from large-industrial-scale processes. It is therefore possible on the one hand to comply with the requirement for “sustainable” products, and on the other hand, however, also to achieve economic production.
The processes for the production of the compounds (I) used according to the invention are simple and efficient, and these can therefore be provided without difficulty on a large industrial scale.

As mentioned above, it has surprisingly been found that the compounds of the general formula (I) comprised in the plasticizer composition of the invention have very low salvation temperatures, and also excellent gelling properties: solvation temperatures of these in accordance with DIN 53408 are markedly below the salvation temperatures of the corresponding dialkyl esters of phthalic acid, and they have at least equivalent rapid-gelling properties.

It has been found that the compounds (I) specifically in combination with dialkyl terephthalates of the general formula (II) are suitable for improving the gelling performance of thermoplastic polymers and elastomers. Even small amounts of the compounds (I) in the plasticizer composition of the invention are sufficient to reduce the temperature required for the gelling and/or to increase the gelling rate.

For the purposes of the present invention, the expression fast fuser means a plasticizer which has a solvation temperature in accordance with DIN 53408 below 120° C. These fast fusers are in particular used for the production of plastisols.

The expression “C₈-alkyl” comprises straight-chain and branched C₈-alkyl groups. It is preferable that C₈-alkyl is selected from n-octyl, isooctyl and 2-ethylhexyl. It is particularly preferable that C₈-alkyl is 2-ethylhexyl.

The expression “C₄-C₁₂-alkyl” comprises straight-chain and branched C₄-C₁₂-alkyl groups. It is preferable that C₄-C₁₂-alkyl is selected from n-butyl, isobutyl, n-pentyl, 2-methylbutyl, 3-methylbutyl, n-hexyl, isohexyl, n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl, 2-propylhexyl, n-decyl, isodecyl, 2-propylheptyl, n-undecyl, isoundecyl, n-dodecyl, isododecyl, and the like. It is particularly preferable that C₄-C₁₂-alkyl is straight-chain and branched C₇-C₁₂-alkyl groups, in particular n-octyl, 2-ethylhexyl, n-nonyl, isononyl, isodecyl, 2-propylheptyl, n-undecyl, or isoundecyl.

It is preferable that the definitions of the groups X in the compounds of the general formula (I) are identical.

In a first preferred embodiment, both of the groups X in the compounds of the general formula (I) are *—(C═O)—O—.

In another preferred embodiment, both of the groups X in the compounds of the general formula (I) are *—(CH₂)—O—(C═O)—.

In another preferred embodiment, both of the groups X in the compounds of the general formula (I) are *—(CH₂)ₙ—O—, where n is 0, 1, or 2. Ills particularly preferable that n is 1.

It is preferable that the moieties R¹ and R² in the compounds of the general formula (I) are mutually independently an unbranched or branched C₈-alkyl moiety selected from n-octyl, isooctyl, and 2-ethylhexyl.

It is particularly preferable that the moieties R¹ and R² in the compounds of the general formula (I) are mutually independently n-octyl or 2-ethylhexyl.

In another particularly preferred embodiment, the definitions of the moieties R¹ and R² in the compounds of the general formula (I) are identical.

In a very particularly preferred embodiment, the moieties R¹ and R² in the compounds of the general formula (I) are 2-ethylhexyl.

Preferred compounds of the general formula (I) are selected from
di(n-octyl) 2,5-furandicarboxylate,
di-n-octyl ether of 2,5-di(hydroxymethyl)furan,
2,5-di(hydroxymethyl)furan di-n-octanoate,
di(isooctyl) 2,5-furandicarboxylate,
diisooctyl ether of 2,5-di(hydroxymethyl)furan,
2,5-di(hydroxymethyl)furan diisooctanoate,
di(2-ethylhexyl) 2,5-furandicarboxylate,
di(2-ethylhexyl) ether of 2,5-di(hydroxymethyl)furan,
2,5-di(hydroxymethyl)furan di-2-ethylhexanoate,

and also mixtures of 2 or more of the abovementioned compounds,

A particularly preferred compound of the general formula (I) is di(2-ethylhexyl) 2,5-furandicarboxylate.

In another preferred embodiment, the definitions of the moieties R³ and R⁴ in the compounds of the general formula (II) are identical.

It is preferable that both of the moieties R³ and R⁴ in the compounds of the general formula (II) are C₇-C₁₂-alkyl, particularly 2-ethylhexyl, or isononyl, or 2-propylheptyl,

A particularly preferred compound of the general formula (II) is di(2-ethylhexyl)-terephthalate.

The properties of the plasticizers can be adjusted to be appropriate to the corresponding intended use via appropriate adjustment of the proportions of the compounds (I) and (II) in the plasticizer composition of the invention. For use in specific application sectors it can optionally be helpful to add, to the plasticizer compositions of the invention, other plasticizers which differ from the compounds (I) and (II). The plasticizer composition of the invention can therefore optionally comprise at least one other plasticizer which differs from the compounds (I) and (II).

The additional plasticizer which differs from the compounds (I) and (II) is selected from dialkyl phthalates, alkyl aralkyl phthalates, dialkyl cyclohexane-1,2-dicarboxylates, trialkyl trimellitates, alkyl benzoates, dibenzoic esters of glycols, hydroxybenzoic esters, esters of saturated mono- and dicarboxylic acids, esters of unsaturated dicarboxylic acids, amides and esters of aromatic sulfonic acids, alkylsulfonic esters, glycerol esters, isosorbide esters, phosphoric esters, citric triesters, alkylpyrrolidone derivatives 2,5-furandicarboxylic esters which differ from compounds (I), 2,5-tetrahydro-furandicarboxylic esters, epoxidized vegetable oils and epoxidized fatty acid monoalkyl esters, polyesters made of aliphatic and/or aromatic polycarboxylic acids with at least dihydric alcohols.

Suitable dialkyl phthalates which can advantageously be mixed with the compounds (I) and (II) have mutually independently from 4 to 13 carbon atoms, preferably from 8 to 13 carbon atoms, in the alkyl chains. An example of a suitable alkyl aralkyl phthalate is benzyl butyl phthalate. Suitable dialkyl cyclohexane-1,2-dicarboxylates have mutually independently from 4 to 13 carbon atoms, preferably from 8 to 13 carbon atoms, in the alkyl chains. An example of a suitable dialkyl cyclohexane-1,2-dicarboxylate is diisononyl cyclohexane-1,2-dicarboxylate. Suitable trialkyl trimellitates preferably have mutually independently in each case from 4 to 13 carbon atoms, in particular from 7 to 11 carbon atoms, in the alkyl chains. Suitable alkyl benzoates preferably have mutually independently in each case from 7 to 13 carbon atoms, in particular from 9 to 13 carbon atoms, in the alkyl chains. Examples of suitable alkyl benzoates are isononyl benzoate, isodecyl benzoate, and 2-propylheptyl benzoate. Suitable dibenzoic esters of glycols are diethylene glycol dibenzoate and dibutylene glycol dibenzoate. Examples of suitable esters of saturated mono- and dicarboxylic acids are esters of acetic acid, butyric acid, valeric acid, succinic acid or lactic acid, and mono- and dialkyl esters of glutaric acid, adipic acid, sebacic acid, malic acid, or tartaric acid. Suitable dialkyl adipates preferably have mutually independently in each case from 4 to 13 carbon atoms, in particular from 6 to 10 carbon atoms, in the alkyl chains. Examples of suitable esters of unsaturated dicarboxylic acids are esters of maleic acid and of fumaric acid. Suitable alkylsulfonic esters preferably have an alkyl moiety having from 8 to 22 carbon atoms. Among these are by way of example phenyl and cresyl esters of pentadecylsulfonic acid. Suitable isosorbide esters are isosorbide diesters, esterified in each case with C₈-C₁₃-carboxylic acids. Suitable phosphoric esters are tri-2-ethylhexyl phosphate, trioctyl phosphate, triphenyl phosphate, isodecyl diphenyl phosphate, bis(2-ethylhexyl) phenyl phosphate, and 2-ethylhexyl diphenyl phosphate. The OH group in the citric triesters can be present in free or carboxylated form, preferably in acetylated form. It is preferable that the alkyl moieties of the acetylated citric triesters have mutually independently from 4 to 8 carbon atoms, in particular from 6 to 8 carbon atoms. Alkylpyrrolidone derivatives having alkyl moieties of from 4 to 18 carbon atoms are suitable. Suitable dialkyl 2,5-furandicarboxylates which differ from the compounds (I) have mutually independently in each case from 4 to 7 carbon atoms, preferably from 4 to 5 carbon atoms, in the alkyl chains. Suitable dialkyl 2,5-tetrahydrofurandicarboxylates have mutually independently in each case from 7 to 13 carbon atoms, preferably from 8 to 12 carbon atoms, in the alkyl chains. A suitable epoxidized vegetable oil is by way of example epoxidized soy oil, obtainable by way of example from Galata Chemicals, Lampertheim, Germany. Epoxidized fatty acid monoalkyl esters, for example obtainable with trademark reFlex™ from PolyOne, USA, are also suitable. The polyesters made of aliphatic and aromatic polycarboxylic acids are preferably polyesters of adipic acid with polyhydric alcohols, in particular dialkylene glycol polyadipates having from 2 to 6 carbon atoms in the alkylene moiety.

In all of the abovementioned cases, the alkyl moieties can in each case be linear or branched and in each case identical or different. Reference is made to the general descriptions relating to suitable and preferred alkyl moieties in the introduction.

The content of the at least one other plasticizer which differs from the compounds (I) and (II) in the plasticizer composition of the invention is usually from 0 to 50% by weight, preferably from 0 to 40% by weight, particularly preferably from 0 to 30% by weight, and in particular from 0 to 25% by weight, based on the entire quantity of the at least one other plasticizer and of the compounds (I) and (II) in the plasticizer composition.

In one preferred embodiment the plasticizer composition of the invention comprises no other plasticizer which differs from the compounds (I) and (II).

It is preferable that the content of the compounds of the general formula (I) in the plasticizer composition of the invention is from 1 to 50% by weight, particularly from 2 to 40% by weight, and in particular from 5 to 35% by weight, based on the total amount of the compounds (I) and (II) in the plasticizer composition.

It is preferable that the content of compounds of the general formula (II) in the plasticizer composition of the invention is from 10 to 99% by weight, particularly from 50 to 99% by weight, very particularly preferably from 60 to 98% by weight, and in particular from 65 to 95% by weight, based on the total amount of the compounds (I) and (II) in the plasticizer composition.

The ratio by weight of compounds of the general formula (I) to compounds of the general formula (II) in the plasticizer composition of the invention is preferably in the range from 1:100 to 1:1, particularly preferably in the range from 1:50 to 1:2, and in particular in the range from 1:20 to 1:2.

Molding Compositions

The present invention further provides a molding composition comprising at least one polymer and one plasticizer composition as defined above.

In one preferred embodiment, the polymer comprised in the molding composition is a thermoplastic polymer.

Thermoplastic polymers that can be used are any of the thermoplastically processable polymers. In particular, these are thermoplastic polymers selected from
homo- and copolymers which comprise at least one copolymerized monomer selected from C₂-C₁₀-monoolefins (such as ethylene or propylene), 1,3-butadiene, 2-chloro-1,3-butadiene, vinyl alcohol and its C₂-C₁₀-alkyl esters, vinyl chloride, vinylidene chloride, vinylidene fluoride, tetrafluoroethylene, glycidyl acrylate, glycidyl methacrylate, acrylates and methacrylates of branched or unbranched C₁-C₁₀-alcohols, vinylaromatics (such as styrene), (meth)acrylonitrile, maleic anhydride, and α,β-ethylenically unsaturated mono- and dicarboxylic acids,
homo- and copolymers of vinyl acetals,
polyvinyl esters,
polycarbonates (PC),
polyesters, such as polyalkylene terephthalates, polyhydroxyalkanoates (PHA), polybutylene succinates (PBS), polybutylene succinate adipates (PBSA),
polyethers,
polyether ketones,
thermoplastic polyurethanes (TPU),
polysulfides,
polysulfones,

and mixtures thereof,

Mention may be made by way of example of polyacrylates having identical or different alcohol moieties from the group of the C₄-C₈-alcohols, particularly of butanol, hexanol, octanol, and 2-ethylhexanol, polymethyl methacrylate (PMMA), methyl methacrylate-butyl acrylate copolymers, acrylonitrile-butadiene-styrene copolymers (ABSs), ethylene-propylene copolymers, ethylene-propylene-diene copolymers (EPDMs), polystyrene (PS), styrene-acrylonitrile copolymers (SANs), acrylonitrile-styrene-acrylate (ASA), styrene-butadiene-methyl methacrylate copolymers (SBMMAs), styrene-maleic anhydride copolymers, styrene-methacrylic acid copolymers (SMAs), polyoxymethylene (POM), polyvinyl alcohol (PVAL), polyvinyl acetate (PVA), polyvinyl butyral (PVB), polycaprolactone (PCL), polyhydroxybutyric acid (FHB), polyhydroxyvaleric acid (PHV), polylactic acid (FLA), ethylcellulose (EC), cellulose acetate (CA), cellulose propionate (CP), and cellulose acetate/butyrate (CAB).

It is preferable that the at least one thermoplastic polymer comprised in the molding composition of the invention is polyvinyl chloride (PVC), polyvinyl butyral (PVB), homo- and copolymers of vinyl acetate, homo- and copolymers of styrene, or is polyacrylates, thermoplastic polyurethanes (TPUs), or polysulfides.

Amounts of plasticizer used differ in accordance with the thermoplastic polymer or thermoplastic polymer mixture comprised in the molding composition. Total plasticizer content in the molding composition is generally from 0.5 to 300 phr (parts per hundred resin=parts by weight per hundred parts by weight of polymer), preferably from 0.5 to 130 phr, particularly preferably from 1 to 100 phr.

Specifically, the at least one thermoplastic polymer comprised in the molding composition of the invention is polyvinyl chloride (PVC).

Polyvinyl chloride is obtained via homopolymerization of vinyl chloride. The polyvinyl chloride (PVC) used in the invention can by way of example be produced via suspension polymerization, microsuspension polymerization, emulsion polymerization, or bulk polymerization. The production of PVC via polymerization of vinyl chloride, and also the production and composition of plasticized PVC, are described by way of example in “Becker/Braun, Kunststoff-Handbuch” [Plastics Handbook], vol. 2/1: Polyvinylchlorid [Polyvinyl chloride], 2nd edn., Carl Hanser Verlag, Munich.

The K value, which characterizes the molar mass of the PVC, and is determined in accordance with DIN 53726, is mostly from 57 to 90 for the PVC plasticized in the invention, preferably from 61 to 85, in particular from 64 to 80.

For the purposes of the invention, the content (% by weight) of PVC in the mixtures is from 20 to 95%, preferably from 40 to 90%, and in particular from 45 to 85%.

If the thermoplastic polymer in the molding compositions of the invention is polyvinyl chloride, total plasticizer content in the molding composition is from 1 to 300 phr, preferably from 5 to 150 phr, particularly preferably from 10 to 130 phr, and in particular from 15 to 120 phr.

The present invention further provides molding compositions comprising at least one elastomer and at least one plasticizer composition as defined above.

It is preferable that the elastomer comprised in the molding compositions of the invention is at least one natural rubber (NR), or at least one synthetic rubber, or a mixture thereof. Examples of preferred synthetic rubbers are polyisoprene rubber (IR), styrene-butadiene rubber (SBR), butadiene rubber (BR), nitrile-butadiene rubber (NBR) and chloroprene rubber (CR).

Preference is given to rubbers or rubber mixtures which can be vulcanized by sulfur.

For the purposes of the invention, the content of elastomer in the molding compositions of the invention is from 20 to 95% by weight, preferably from 45 to 90% by weight, and in particular from 50 to 85% by weight.

For the purposes of the invention, the molding compositions which comprise at least one elastomer can comprise other suitable additives, in addition to the above constituents. By way of example, the materials may comprise reinforcing fillers, such as carbon black or silicon dioxide, other fillers, a methylene donor, such as hexamethylenetetramine (HMT), a methylene acceptor, such as phenolic resins modified with Cardanol (from cashew nuts), a vulcanizing agent or crosslinking agent, a vulcanizing accelerator or crosslinking accelerator, activators, various types of oil, antioxidants, and other various additives which by way of example can be mixed into tire compositions and into other rubber compositions.

If the polymer in the molding compositions of the invention consists of rubbers, the content of the plasticizer composition of the invention, as defined above, in the molding composition consists of from 1 to 60 phr, preferably from 1 to 40 phr, particularly preferably from 2 to 30 phr.

Molding Composition Additives

For the purposes of the invention, the molding compositions comprising at least one thermoplastic polymer can comprise other suitable additives. By way of example, the materials can comprise lubricants, fillers, pigments, flame retardants, light stabilizers and other stabilizers, blowing agents, polymeric processing aids impact modifiers, optical brighteners, antistatic agents, or biostabilizers.

Some suitable additives are described in more detail below. However, the examples listed do not represent any restriction of the molding compositions of the invention, but instead serve merely for illustration. All data relating to content are in % by weight, based on the entire molding composition.

Stabilizers that can be used are any of the conventional PVC stabilizers in solid and liquid form, for example conventional Ca/Zn, Ba/Zn, Pb, or Sn stabilizers, and also acid-binding phyllosilicates, such as hydrotalcite.

The molding compositions of the invention can have from 0.05 to 7% content of stabilizers, preferably from 0.1 to 5%, particularly preferably from 0.2 to 4%, and in particular from 0.5 to 3%.

Lubricants reduce adhesion between the plastics to be processed and metal surfaces, and are intended to counteract frictional forces during mixing, plastification, and deformation.

The molding compositions of the invention can comprise, as lubricants, any of the lubricants conventionally used for the processing of plastics. Examples of those that can be used are hydrocarbons, such as oils, paraffins, and PE waxes, fatty alcohols having from 6 to 20 carbon atoms, ketones, carboxylic acids, such as fatty acids and montanic acid, oxidized PE wax, metal salts of carboxylic acids, carboxamides, and also carboxylic esters, for example with the following alcohols: ethanol, fatty alcohols, glycerol, ethanediol, and pentaerythritol, and with long-chain carboxylic acids as acid component.

The molding compositions of the invention can have from 0.01 to 10% lubricant content, preferably from 0.05 to 5%, particularly preferably from 0.1 to 3%, and in particular from 0.2 to 2%.

Fillers have an advantageous effect primarily on the compressive strength, tensile strength, and flexural strength, and also the hardness and heat resistance, of plasticized PVC.

For the purposes of the invention, the molding compositions can also comprise fillers such as carbon black and other organic fillers such as natural calcium carbonates, for example chalk, limestone, and marble, dolomite, silicates, silica, sand, diatomaceous earth, aluminum silicates, such as kaolin, mica, and feldspar, and synthetic calcium carbonates. It is preferable to use the following as fillers: calcium carbonates, chalk, dolomite, kaolin, silicates, talc powder, or carbon black.

The molding compositions of the invention can have from 0.01 to 80% content of fillers, preferably from 0.1 to 60%, particularly preferably from 0.5 to 50%, and in particular from 1 to 40%.

The molding compositions of the invention can also comprise pigments in order to adapt the resultant product to be appropriate to various possible uses.

For the purposes of the present invention, it is possible to use either inorganic pigments or organic pigments. Examples of inorganic pigments that can be used are cobalt pigments, such as CoO/Al₂O₃, and chromium pigments, such as Cr₂O₃. Examples of organic pigments that can be used are monoazo pigments, condensed azo pigments, azomethine pigments, anthraquinone pigments, quinacridones, phthalocyanine pigments, and dioxazine pigments.

The molding compositions of the invention can have from 0.01 to 10% content of pigments, preferably from 0.05 to 5%, particularly preferably from 0.1 to 3%, and in particular from 0.5 to 2%.

In order to reduce flammability and to reduce smoke generation during combustion, the molding compositions of the invention can also comprise flame retardants.

Examples of flame retardants that can be used are antimony trioxide, phosphate esters, chloroparaffin, aluminum hydroxide, and boron compounds.

The molding compositions of the invention can have from 0.01 to 10% content of flame retardants, preferably from 0.1 to 8%, particularly preferably from 0.2 to 5%, and in particular from 0.5 to 2%.

The molding compositions can also comprise light stabilizers, e.g. UV absorbers, in order to protect items produced from the molding compositions of the invention from surface damage due to the effect of light.

For the purposes of the present invention, examples of light stabilizers that can be used are hydroxybenzophenones, hydroxyphenylbenzotriazoles, cyanoacrylates, and what are known as hindered aminine light stabilizers (HALS), such as the derivatives of 2,2,6,6-tetramethylpiperidine.

The molding compositions of the invention can have from 0.01 to 7% content of light stabilizers, e.g. UV absorbers, preferably from 0.1 to 5%, particularly preferably from 0.2 to 4%, and in particular from 0.5 to 3%.

Production of the Compounds of the General Formula (I)

The production of the compounds of the general formula (I) comprised in the plasticizer compositions of the invention is described below.

Production of the diesters of 2,5-furandicarboxylic acids

Compounds of the general formula (I.1),

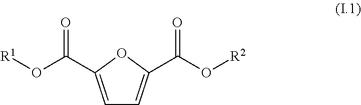

in which the definitions of R¹ and R² are as above, are obtainable via a process where
a) optionally 2,5-furandicarboxylic acid or an anhydride or acyl halide thereof is reacted with a C₁-C₃-alkanol in the presence of a catalyst to give a di(C₁-C₃-alkyl) 2,5-furandicarboxylate,
b) 2,5-furandicarboxylic acid or an anhydride or acyl halide thereof, or the di(C₁-C₃-alkyl) 2,5-furandicarboxylate obtained in step a), is reacted with at least one alcohol R¹—OH and, if R¹ and R² are different, also with at least one alcohol R²—OH, in the presence of at least one catalyst to give a compound of the formula (I.1).

In respect of suitable and preferred embodiments of the moieties R¹ and R², reference is made to the entirety of the information provided above.

Examples of C₁-C₃-alkanols suitable for use in step a) are methanol, ethanol, n-propanol, and mixtures thereof.

In step b) of the process, the 2,5-furandicarboxylic acid or the di(C₁-C₃-alkyl) 2,5-furandicarboxylate obtained in step a) is subjected to esterification or transesterification with at least one alcohol R¹—OH and, if R¹ and R² are different, also with at least one alcohol R²—OH, to give the compounds of the formula (I.1).

Esterification

Conventional processes known to the person skilled in the art can be used to convert the 2,5-furandicarboxylic acid (FDCA) to the corresponding di(C₁-C₃-alkyl) 2,5-furandicarboxylates and/or ester compounds of the general formulae (I.1). Among these are the reaction of at least one alcohol component selected from C₁-C₃-alkanols or from the alcohols R¹—OH and, respectively, R²—OH with FDCA or a suitable derivative thereof. Examples of suitable derivatives are the acyl halides and anhydrides. A preferred acyl halide is the acyl chloride. Esterification catalysts that can be used are the catalysts conventionally used for this purpose, e.g. mineral acids, such as sulfuric acid and phosphoric acid; organic sulfonic acids, such as methanesulfonic acid and p-toluenesulfonic acid; amphoteric catalysts, in particular titanium compounds, tin(IV) compounds, or zirconium compounds, e.g. tetraalkoxytitanium compounds, e.g. tetrabutoxytitanium, and tin(IV) oxide. The water produced during the reaction can be removed by conventional measures, e.g. by distillation. WO 02/38531 describes a process for producing esters of polybasic carboxylic acids where a) a mixture consisting essentially of the acid component or of an anhydride thereof and of the alcohol component is heated to boiling point in the presence of an esterification catalyst in a reaction zone, b) the vapors comprising alcohol and water are fractionated to give an alcohol-rich fraction and a water-rich fraction, c) the alcohol-rich fraction is returned to the reaction zone, and the water-rich fraction is discharged from the process. The process described in WO 02/38531 and the catalysts disclosed therein are likewise suitable for the esterification reaction.

An effective amount of the esterification catalyst is used and is usually in the range from 0.05 to 10% by weight, preferably from 0.1 to 5% by weight, based on the entirety of acid component (or anhydride) and alcohol component.

Other suitable processes for preparing the compounds of the general formula (I.1) by esterification are described by way of example in U.S. Pat. No. 6,310,235, U.S. Pat. No. 5,324,853, DE-A 2612355 or DE-A 1945359. The entirety of the documents mentioned is incorporated herein by way of reference.

In general, the esterification of FDCA is preferably carried out in the presence of the alcohol components described above by means of an organic acid or mineral acid, in particular concentrated sulfuric acid. The amount used of the alcohol component here is advantageously at least twice the stochiometric amount, based on the amount of FDCA or a suitable derivative thereof in the reaction mixture.

The esterification can generally take place at ambient pressure or at reduced or elevated pressure. It is preferable that the esterification is carried out at ambient pressure or reduced pressure.

The esterification can be carried out in the absence of any added solvent or in the presence of an organic solvent.

If the esterification is carried out in the presence of a solvent, it is preferable that this is an organic solvent that is inert under the reaction conditions. Among these are by way of example aliphatic hydrocarbons, halogenated aliphatic hydrocarbons, and aromatic and substituted aromatic hydrocarbons and ethers. It is preferable that the solvent is one selected from pentane, hexane, heptane, ligroin, petroleum ether, cyclohexane, dichloromethane, trichloromethane, tetrachloromethane, benzene, toluene, xylene, chlorobenzene, dichlorobenzenes, dibutyl ether, THF, dioxane, and mixtures thereof.

The esterification is usually carried out in a temperature range from 50 to 250° C.

If the esterification catalyst is selected from organic acids or mineral acids, the esterification is usually carried out in the temperature range from 50 to 160° C.

If the esterification catalyst is selected from amphoteric catalysts, the esterification is usually carried out in the temperature range from 100 to 250° C.

The esterification can take place in the absence of or in the presence of an inert gas. The expression inert gas generally means a gas which under the prevailing reaction conditions does not enter into any reactions with the starting materials, reagents, or solvents participating in the reaction, or with the resultant products.

Transesterification:

Conventional processes known to the person skilled in the art can be used for the transesterification, described in step b), of the di(C₁-C₃-alkyl) 2,5-furandicarboxylates to give the corresponding ester compounds I.1. Among these are the reaction of the di(C₁-C₃)-alkyl esters with at least one C₈-alkanol in the presence of a suitable transesterification catalyst.

Transesterification catalysts that can be used are the conventional catalysts usually used for transesterification reactions, where these are mostly also used in esterification reactions. Among these are by way of example mineral acids, such as sulfuric acid and phosphoric acid; organic sulfonic acids, such as methanesulfonic acid and p-toluenesulfonic acid; and specific metal catalysts from the group of the tin(IV) catalysts, for example dialkyltin dicarboxylates, such as dibutyltin diacetate, trialkyltin alkoxides, monoalkyltin compounds, such as monobutyltin dioxide, tin salts, such as tin acetate, or tin oxides; from the group of the titanium catalysts: monomeric and polymeric titanates and titanium chelates, for example tetraethyl orthotitanate, tetrapropyl orthotitanate, tetrabutyl orthotitanate, triethanolamine titanate; from the group of the zirconium catalysts: zirconates and zirconium chelates, for example tetrapropyl zirconate, tetrabutyl zirconate, triethanolamine zirconate; and also lithium catalysts, such as lithium salts, lithium alkoxides; and aluminum(III) acetylacetonate, chromium(III) acetylacetonate, iron(III) acetylacetonate, cobalt(II) acetylacetonate, nickel(II) acetylacetonate, and zinc(II) acetylacetonate.

The amount of transesterification catalyst used is from 0.05 to 5% by weight, preferably from 0.1 to 1% by weight. The reaction mixture is preferably heated to the boiling point of the reaction mixture, the reaction temperature therefore being from 20° C. to 200° C., depending on the reactants.

The transesterification can take place at ambient pressure or at reduced or elevated pressure. It is preferable that the transesterification is carried out at a pressure of from 0.001 to 200 bar, particularly from 0.01 to 5 bar. The relatively low-boiling-point alcohol eliminated during the transesterification is preferably continuously removed by distillation in order to shift the equilibrium of the transesterification reaction. The distillation column necessary for this purpose generally has direct connection to the transesterification reactor, and it is preferable that said column is a direct attachment thereto. If a plurality of transesterification reactors are used in series, each of said reactors can have a distillation column, or the vaporized alcohol mixture can preferably be introduced into a distillation column from the final tanks of the transesterification reactor cascade by way of one or more collection lines. The relatively high-boiling-point alcohol reclaimed in said distillation is preferably returned to the transesterification.

If an amphoteric catalyst is used, this is generally removed via hydrolysis and subsequent removal of the resultant metal oxide, e.g. via filtration. It is preferable that, after reaction has been completed, the catalyst is hydrolyzed by means of washing with water, and the precipitated metal oxide is removed by filtration. The filtrate can, if desired, be subjected to further work-up for the isolation and/or purification of the product. It is preferable that the product is isolated by distillation.

The transesterification of the di(C₁-C₃-alkyl) 2,5-furandicarboxylates preferably takes place in the presence of the alcohol component and in the presence of at least one titanium(IV) alcoholate. Preferred titanium(IV) alcoholates are tetrapropoxytitanium, tetrabutoxytitanium, and mixtures thereof. It is preferable that the amount used of the alcohol component is at least twice the stochiometric amount, based on the di(C₁-C₃-alkyl) ester used.

The transesterification can be carried out in the absence of, or in the presence of, an added organic solvent. It is preferable that the transesterification is carried out in the presence of an inert organic solvent. Suitable organic solvents are those mentioned above for the esterification. Among these are specifically toluene and THF.

The transesterification is preferably carried out in the temperature range from 50 to 200° C.

The transesterification can take place in the absence of or in the presence of an inert gas. The expression inert gas generally means a gas which under the prevailing reaction conditions does not enter into any reactions with the starting materials, reagents, or solvents participating in the reaction, or with the resultant products. It is preferable that the transesterification takes place without addition of any inert gas.

One particularly suitable embodiment of the process comprises:
a) reaction of 2,5-furandicarboxylic acid with methanol in the presence of concentrated sulfuric acid to give dimethyl 2,5-furandicarboxylate,
b) reaction of the dimethyl 2,5-furandicarboxylate obtained in step a) with at least one alcohol R¹—OH in the presence of at least one titanium(IV) alcoholate to give the compounds of the general formula (I.1).

Production of the C₈-diether derivatives and, respectively, C₈-diester derivatives of the formulae (I.2) and, respectively, (I.3)

Compounds of the general formula (I.2) or (I.3),

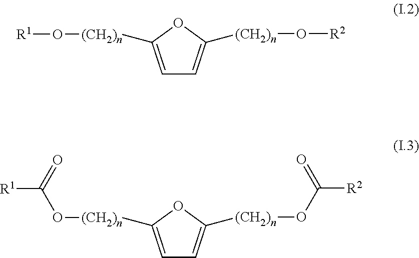

in which one of the abovementioned definitions applies to R¹ and R², and n has the value 1 or 2, are obtainable via a process where
a) 2,5-di(hydroxymethyl)furan (n=1) or 2,5-Di(hydroxyethyl)furan (n=2) is reacted with at least one alkylating reagent R¹—Z and, if R¹ differs from R², also with at least one alkylating reagent R²—Z, where Z is a leaving group, in the presence of a base to give compounds of the formula (I.2),

or
b) 2,5-di(hydroxymethyl)furan (n=1) or 2,5-di(hydroxyethyl)furan (n=2) is reacted with at least one acyl halide R¹—(C═O)X and, if R¹ differs from R², also with at least one acyl halide R²—(C═O)X, where X is Br or Cl, in the presence of at least one tertiary amine compound of the formula (I.3).

The alkylation is generally carried out in the presence of an organic solvent that is inert under the reaction conditions. Suitable solvents are those previously mentioned for the esterification. Aromatic hydrocarbons, such as toluene, are preferred as solvent.

The leaving group Z is preferably a moiety selected from Br, Cl, and the tosyl, mesyl, and triflyl group.

It is particularly preferable that the leaving group Z is Br.

The alkylation reagents R¹—Z and R²—Z can be purchased from commercial sources or can be produced by way of suitable reactions or procedures familiar to the person skilled in the art, from the corresponding alcohols. By way of example, the alkyl bromides R¹—Br and, respectively, R²—Br preferably used for this process can be produced in a known manner on a large industrial scale from the appropriate alcohols R¹—OH and, respectively, R²—OH by using hydrogen bromide (HBr).

Suitable bases that can be used are mineral bases and/or strong organic bases. Among these are by way of example inorganic bases or base-formers, for example hydroxides, hydrides, amides, oxides, and carbonates of the alkali metals and of the alkaline earth metals. Among these are LiOH, NaOH, KOH, Mg(OH)₂, Ca(OH)₂, LiH, NaH, sodium amide (NaNH₂), lithium diisopropylamide (LDA), Na₂O, K₂CO₃, Na₂CO₃ and Cs₂CO₃; and also organometallic compounds, such as n-BuLi, or tert-BuLi. Preference is given to NaOH, KOH, K₂CO₃, and Na₂CO₃.

The amount used here of the base is preferably at least a two-fold stoichiometric excess, based on the 2,5-di(hydroxymethyl)furan and, respectively, 2,5-di(hydroxy-ethyl)furan. It is particularly preferable to use an at least four-fold stoichiometric excess of base.

The alkylation can be carried out in the absence of, or in the presence of, an organic solvent. The reaction is generally carried out in the presence of an inert organic solvent, such as pentane, hexane, heptane, ligroin, petroleum ether, cyclohexane, dichloromethane, trichloromethane, tetrachloromethane, benzene, toluene, xylene, chlorobenzene, dichlorobenzenes, dibutyl ether, THF, dioxane, or a mixture thereof.

The alkylation can generally take place at ambient pressure, reduced pressure, or elevated pressure. It is preferable that the alkylation is carried out at ambient pressure.

It is preferable that the alkylation is carried out in the temperature range from 30 to 200° C., preferably from 50 to 150° C.

The alkylation can take place in the absence of, or in the presence of, an inert gas. It is preferable that the alkylation uses no inert gas.

In one specific suitable embodiment of the alkylation, 2,5-di(hydroxymethyl)furan or 2,5-di(hydroxyethyl)furan is converted to the diether compounds of the general formula (I.2) in the presence of an at least four-fold excess of base in an inert organic solvent and with at least one alkyl bromide R¹—Br and, respectively, R²—Br. In relation to the moieties R¹ and R², reference is made to the previous descriptions. As base, it is preferable to use an alkali metal hydroxide, in particular KOH.

To produce the ester compounds of the general formula (I.3), it is preferable to react 2,5-di(hydroxymethyl)furan or 2,5-di(hydroxyethyl)furan with at least one acyl halide R¹—(C═O)X and, if R¹ and R² are different, with at least one acyl halide R²—(C═O)X, where X is Br or Cl, in the presence of at least one tertiary amine, to give the compounds of the formula (I.3).

There are also other familiar esterification methods, alongside this process, available to the person skilled in the art, as previously described in relation to the esterification of FDCA.

The ester compounds of the general formula (I.3) can usually be produced by using any of the tertiary amines familiar to the person skilled in the art. Examples of suitable tertiary amines are:
from the group of the trialkylamines: trimethylamine, triethylamine, tri-n-propylamine, diethylisopropylamine, diisopropylethylamine and the like;
from the group of the N-cycloalkyl-N,N-dialkylamines: dimethylcyclohexylamine and diethylcyclohexylamine;
from the group of the N,N-dialkylanilines: dimethylaniline and diethylaniline;
from the group of the pyridine and quinoline bases: pyridine, α-, β-, and γ-picoline, quinoline und 4-(dimethylamino)pyridine (DMAP).

Preferred tertiary amines are trialkylamines and pyridine bases, in particular triethylamine and 4-(dimethylamino)pyridine (DMAP), and also mixtures thereof.

The esterification can take place at ambient pressure, or at reduced or elevated pressure. It is preferable to carry out the esterification at ambient pressure.

The esterification can be carried out in the absence of, or in the presence of, an organic solvent. It is preferable to carry out the esterification in the presence of an inert organic solvent, as defined previously.

The esterification is usually carried out in the temperature range from 50 to 200° C.,

The esterification can take place in the absence of, or in the presence of, an inert gas.

In one preferred embodiment of the process for the production of the compounds I.3, 2,5-di(hydroxymethyl)furan is reacted with an acyl chloride R¹—(C═O)Cl in the presence of triethylamine and/or DMAP and of an inert organic solvent to give compounds of the formula (I.3).

C₈-Alkanols are used as starting materials for the production of the compounds of the general formula (I).

Preferred C₈-alkanols can be straight-chain or branched compounds, or can be composed of mixtures of straight-chain and branched C₈-alkanols. Among these are n-octanol, isooctanol, and 2-ethylhexanol, and also mixtures thereof. Preference is given to n-octanol and 2-ethylhexanol. Particular preference is given to 2-ethylhexanol.

The furan-2,5-dicarboxylic acid (FDCA, CAS No. 3238-40-2) used for producing compounds of the general formula (I) can either be purchased commercially or can be produced by synthesis routes known from the literature: possibilities for synthesis are found in the publication by Lewkowski et al published on the Internet with the title “Synthesis, Chemistry and Application of 5-hydroxymethylfurfural and its derivatives” (Lewkowski et at, ARKIVOC 2001 (i), pp. 17-54, ISSN 1424-6376). A feature common to most of these syntheses is acid-catalyzed reaction of carbohydrates, particularly glucose and fructose, preferably fructose, to give 5-hydroxymethylfurfural (5-HMF), which can be separated from the reaction mixture by using technical processes such as a two-phase method. Appropriate results have been described by way of example by Leshkov et al. in Science 2006, vol. 312, pp. 1933-1937, and by Zhang et al. in Angewandte Chemie 2008, vol. 120, pp. 9485-9488. 5-HMF can then be oxidized to FDCA in a further step, as cited by way of example by Christensen in ChemSusChem 2007, vol. 1, pp. 75-78.

2,5-bis(hydroxymethyl)furan (CAS No. 1883-75-6) can likewise either be purchased or can be synthesized. The syntheses described start from 5-HMF, which can be reduced in two steps by way of 2,5-bis(hydroxymethyl)furan (2,5-BHF) (Lewkowski et at, ARKIVOC 2001 (i), pp. 17-54, ISSN 1424-6376).

2,5-bis(hydroxyethyl)furan can be obtained via reduction of methyl 2,5-furandiacetate. Methyl 2,5-furandiacetate can be synthesized by way of suitable reactions familiar to the person skilled in the art from 2,5-bis(hydroxymethyl)furan (2,5-BHF), for example by analogy with the process described by Rau et al. in Liebigs Ann. Chem., vol. 1984 (8. 1984), pp. 1504-1512, ISSN 0947-3440. Here, 2,5-bis(chloromethyl)furan is prepared from 2,5-BHF via reaction with thionyl chloride, and is reacted via exposure to KCN in benzene in the presence of [18]-crown-6 to give 2,5-bis(cyanomethyl)furan, 2,5-bis(cyanomethyl)furan can then be hydrolyzed to give 2,5-furandiacetic acid and esterified with methanol to give the dimethyl ester, or can be converted directly to methyl 2,5-furandiacetate via alcoholysis with methanol (Pinner reaction). Methyl 2,5-furandiacetate can then be reduced to 2,5-bis(hydroxyethyl)furan.

Methyl 2,5-furandiacetate can likewise be prepared by analogy with the process described by Kern et al. in Liebigs Ann. Chem., vol. 1985 (6. 1985), pp. 1168-1174, ISSN 0947-3440.

Compounds of the General Formula (II)

The compounds of the general formula (II) can either be purchased or produced by processes known in the prior art.

The dialkyl terephthalates are generally obtained via esterification of terephthalic acid or of suitable derivatives thereof with the corresponding alcohols. The esterification can take place by conventional processes known to the person skilled in the art.

A feature common to the processes for the production of the compounds of the general formula (II) is that, starting from terephthalic acid or suitable derivatives thereof, an esterification or transesterification reaction is carried out, where the corresponding C₄-C₁₂-alkanols are used as starting materials. These alcohols are generally not pure substances, instead being isomer mixtures of which the composition and purity depends on the particular process by which they are prepared.

Preferred C₄-C₁₂-alkanols which are used for the production of the compounds (II) comprised in the plasticizer composition can be straight-chain or branched, or can be composed of mixtures of straight-chain and branched C₄-C₁₂-alkanols. Among these are n-butanol, isobutanol, n-pentanol, isopentanol, n-hexanol, isohexanol, n-heptanol, isoheptanol, n-octanol, isooctanol, 2-ethylhexanol, n-nonanol, isononanol, isodecanol, 2-propylheptanol, n-undecanol, isoundecanol, n-dodecanol, and isododecanol.

Particularly preferred are C₇-C₁₂-alkanols, in particular 2-ethylhexanol, isononanol, and 2-propylheptanol, especially 2-ethylhexanol.

Compounds of the general formula II are obtainable commercially. An example of a suitable commercially obtainable plasticizer of the general formula II is di(2-ethylhexyl) terephthalate (DOTP) marketed with trademark Palatinol® DOTP by BASF Corp., Florham Park, N.J., USA.

Heptanol

The heptanols used for the production of the compounds of the general formula (II) can be straight-chain or branched or can be composed of mixtures of straight-chain and branched heptanols. It is preferable to use mixtures of branched heptanols, also known as isoheptanol, which are produced via rhodium- or preferably cobalt-catalyzed hydroformylation of propene dimer, obtainable by way of example by the Dimersol® process, and subsequent hydrogenation of the resultant isoheptanals to give an isoheptanol mixture. Because of the process used for its production, the resultant isoheptanol mixture is composed of a plurality of isomers. Substantially straight-chain heptanols can be obtained via rhodium- or preferably cobalt-catalyzed hydroformylation of 1-hexene and subsequent hydrogenation of the resultant n-heptanal to give n-heptanol. The hydroformylation of 1-hexene or of propene dimer can be achieved by methods known per se: compounds used as catalyst in hydroformylation with rhodium catalysts homogeneously dissolved in the reaction medium can be not only uncomplexed rhodium carbonyl compounds which are formed in situ under the conditions of the hydroformylation reaction within the hydroformylation reaction mixture on exposure to synthesis gas, e.g. from rhodium salts, but also complex rhodium carbonyl compounds, in particular complexes with organic phosphines, such as triphenylphosphine, or with organophosphites, preferably chelating biphosphites, as described by way of example in U.S. Pat. No. 5,288,918. Compounds used in the cobalt-catalyzed hydroformylation of these olefins are generally cobalt carbonyl compounds which are homogeneously soluble in the reaction mixture and which are formed in situ from cobalt salts under the conditions of the hydroformylation reaction on exposure to synthesis gas. If the cobalt-catalyzed hydroformylation is carried out in the presence of trialkyl- or triarylphosphines, the desired heptanols are formed directly as hydroformylation product, and there is therefore then no need for further hydrogenation of the aldehyde function.

Examples of suitable processes for the cobalt-catalyzed hydroformylation of 1-hexene or of the hexene isomer mixtures are the established industrial processes explained on pages 162-168 of Falbe, New Syntheses with Carbon Monoxide, Springer, Berlin, 1980, an example being the Ruhrchemie process, the BASF process, the Kuhlmann process, or the Shell process. Whereas the Ruhrchemie, BASF, and Kuhlmann process operate with non-ligand-modified cobalt carbonyl compounds as catalysts and thus give hexanal mixtures, the Shell process (DE-A 1593368) uses, as catalyst, phosphine- or phosphite-ligand-modified cobalt carbonyl compounds which lead directly to the hexanol mixtures because they also have high hydrogenation activity. DE-A 2139630, DE-A 2244373, DE-A 2404855, and WO 01014297 provide detailed descriptions of advantageous embodiments for the conduct of the hydroformylation with non-ligand-modified cobalt carbonyl complexes.

The rhodium-catalyzed hydroformylation of 1-hexene or of the hexene isomer mixtures can use the established industrial low-pressure rhodium hydroformylation process with triphenylphosphine-ligand-modified rhodium carbonyl compounds, which is subject matter of U.S. Pat. No. 4,148,830. Non-ligand-modified rhodium carbonyl compounds can serve advantageously as catalyst for the rhodium-catalyzed hydroformylation of long-chain olefins, for example of the hexene isomer mixtures obtained by the processes described above; this differs from the low-pressure process in requiring a higher pressure of from 80 to 400 bar. The conduct of high-pressure rhodium hydroformylation processes of this type is described by way of example in EP-A 695734, EP-B 880494, and EP-B 1047655.

The isoheptanal mixtures obtained after hydroformylation of the hexene isomer mixtures are catalytically hydrogenated in a manner that is per se conventional to give isoheptanol mixtures. For this purpose it is preferable to use heterogeneous catalysts which comprise, as catalytically active component, metals and/or metal oxides of groups VI to VIII, or else of transition group I, of the Periodic Table of the Elements, in particular chromium, molybdenum, manganese, rhenium, iron, cobalt, nickel, and/or copper, optionally deposited on a support material, such as Al₂O₃, SiO₂ and/or TiO₂. Catalysts of this type are described by way of example in DE-A 3228881, DE-A 2628987, and DE-A 2445303. It is particularly advantageous to carry out the hydrogenation of the isoheptanals with an excess of hydrogen of from 1.5 to 20% above the stoichiometric amount of hydrogen needed for the hydrogenation of the isoheptanals, at temperatures of from 50 to 200° C., and at a hydrogen pressure of from 25 to 350 bar, and for avoidance of side-reactions to add, during the course of the hydrogenation, in accordance with DE-A 2628987, a small amount of water, advantageously in the form of an aqueous solution of an alkali metal hydroxide or alkali metal carbonate, in accordance with the teaching of WO 01087809.

Octanol

For many years, 2-ethylhexanol was the largest-production-quantity plasticizer alcohol, and it can be obtained through the aldol condensation of n-butyraldehyde to give 2-ethylhexanal and subsequent hydrogenation thereof to give 2-ethylhexanol (see Ullmann's Encyclopedia of Industrial Chemistry; 5th edition, vol. A 10, pp. 137-140, VCH Verlagsgesellschaft GmbH, Weinheim 1987).

Substantially straight-chain octanols can be obtained via rhodium- or preferably cobalt-catalyzed hydroformylation of 1-heptene and subsequent hydrogenation of the resultant n-octanal to give n-octanol. The 1-heptene needed for this purpose can be obtained from the Fischer-Tropsch synthesis of hydrocarbons.

By virtue of the production route used for the alcohol isooctanol, it is not a unitary chemical compound, in contrast to 2-ethylhexanol or n-octanol, but instead is an isomer mixture of variously branched Cc-alcohols, for example of 2,3-dimethyl-1-hexanol, 3,5-dimethyl-1-hexanol, 4,5-dimethyl-1-hexanol, 3-methyl-1-heptanol, and 5-methyl-1-heptanol; these can be present in the isooctanol in various quantitative proportions which depend on the production conditions and production processes used. Isooctanol is usually produced via codimerization of propene with butenes, preferably n-butenes, and subsequent hydroformylation of the resultant mixture of heptene isomers. The octanal isomer mixture obtained in the hydroformylation can subsequently be hydrogenated to give the isooctanol in a manner that is conventional per se.

The codimerization of propene with butenes to give isomeric heptenes can advantageously be achieved with the aid of the homogeneously catalyzed Dimersol® process (Chauvin et al; Chem. Ind.; May 1974, pp. 375-378), which uses, as catalyst, a soluble nickel phosphine complex in the presence of an ethylaluminum chlorine compound, for example ethylaluminum dichloride. Examples of phosphine ligands that can be used for the nickel complex catalyst are tributylphosphine, triisopropyl-phosphine, tricyclohexylphosphine, and/or tribenzylphosphine. The reaction takes place at temperatures of from 0 to 80° C., and it is advantageous here to set a pressure at which the olefins are present in solution in the liquid reaction mixture (Cornils; Hermann: Applied Homogeneous Catalysis with Organometallic Compounds; 2^{nd} edition, vol. 1; pp. 254-259, Wiley-VCH, Weinheim 2002).

In an alternative to the Dimersol® process operated with nickel catalysts homogeneously dissolved in the reaction medium, the codimerization of propene with butenes can also be carried out with a heterogeneous NiO catalyst deposited on a support; heptene isomer distributions obtained here are similar to those obtained in the homogeneously catalyzed process. Catalysts of this type are by way of example used in what is known as the Octol® process (Hydrocarbon Processing, February 1986, pp. 31-33), and a specific heterogeneous nickel catalyst with good suitability for olefin dimerization or olefin codimerization is disclosed by way of example in WO 9514647.

Codimerization of propene with butenes can also use, instead of nickel-based catalysts, heterogeneous Brønsted-acid catalysts; heptenes obtained here are generally more highly branched than in the nickel-catalyzed processes. Examples of catalysts suitable for this purpose are solid phosphoric acid catalysts, e.g. phosphoric-acid-impregnated kieselguhr or diatomaceous earth, these being as utilized in the PolyGas® process for olefin dimerization or olefin oligomerization (Chitnis et al; Hydrocarbon Engineering 10, No. 6-June 2005). Brønsted-acid catalysts that have very good suitability for the codimerization of propene and butenes to give heptenes are zeolites, which are used in the EMOGAS® process, a further development based on the PolyGas® process.

The 1-heptene and the heptene isomer mixtures are converted to n-octanal and, respectively, octanal isomer mixtures by the known processes explained above in connection with the production of n-heptanal and heptanal isomer mixtures, by means of rhodium- or cobalt-catalyzed hydroformylation, preferably cobalt-catalyzed hydroformylation. These are then hydrogenated to give the corresponding octanols, for example by means of one of the catalysts mentioned above in connection with production of n-heptanol and of isoheptanol.

Nonanol

Substantially straight-chain nonanol can be obtained via rhodium- or preferably cobalt-catalyzed hydroformylation of 1-octene and subsequent hydrogenation of the resultant n-nonanal. The starting olefin 1-octene can be obtained by way of example by way of ethylene oligomerization by means of a nickel complex catalyst that is homogenously soluble in the reaction medium—1,4-butanediol—with, for example, diphenyl-phosphinoacetic acid or 2-diphenylphosphinobenzoic acid as ligand. This process is also known as the Shell Higher Olefins Process or SHOP process (see Weisermel, Arpe: Industrielle Organische Chemie [Industrial organic chemistry]; 5th edition, p. 96; Wiley-VCH, Weinheim 1998).

Isononanol used for the synthesis of the diisononyl esters of general formula (II) comprised in the plasticizer composition of the invention is not a unitary chemical compound, but instead is a mixture of variously branched, isomeric C₉-alcohols which can have various degrees of branching depending on the manner in which they were produced, and also in particular on the starting materials used. The isononanols are generally produced via dimerization of butenes to give isooctene mixtures, subsequent hydroformylation of the isooctene mixtures, and hydrogenation of the resultant isononanal mixtures to give isononanol mixtures, as explained in Ullmann's Encyclopedia of Industrial Chemistry, 5th edition, vol. A1, pp. 291-292, VCH Verlagsgesellschaft GmbH, Weinheim 1995.

Isobutene, cis- and trans-2-butene, and also 1-butene, or a mixture of these butene isomers, can be used as starting material for the production of the isononanols. The dimerization of pure isobutene, mainly catalyzed by means of liquid Brønsted acids, e.g. sulfuric acid or phosphoric acid, or by means of solid Brønsted acids, e.g. phosphoric acid applied to kieselguhr, SiO₂, or Al₂O₃, as support material, or zeolites, mainly gives the highly branched compound 2,4,4-trimethylpentene, also termed diisobutylene, which gives highly branched isononanols after hydroformylation and hydrogenation of the aldehyde.

Preference is given to isononanols with a low degree of branching. Isononanol mixtures of this type with little branching are prepared from the linear butenes 1-butene, cis- and/or trans-2-butene, which optionally can also comprise relatively small amounts of isobutene, by way of the route described above involving butene dimerization, hydroformylation of the isooctene, and hydrogenation of the resultant isononanal mixtures. A preferred raw material is what is known as raffinate II, which is obtained from the Ca-cut of a cracker, for example of a steam cracker, after elimination of allenes, acetylenes, and dienes, in particular 1,3-butadiene, via partial hydrogenation thereof to give linear butenes, or removal thereof via extractive distillation, for example by means of N-methylpyrrolidone, and subsequent Brønsted-acid catalyzed removal of the isobutene comprised therein via reaction thereof with methanol or isobutanol by established large-scale-industrial processes with formation of the fuel additive methyl tert-butyl ether (MTBE), or of the isobutyl tert-butyl ether that is used to obtain pure isobutene.

Raffinate II also comprises, alongside 1-butene and cis- and trans-2-butene, n- and isobutane, and residual amounts of up to 5% by weight of isobutene.

The dimerization of the linear butenes or of the butene mixture comprised in raffinate II can be carried out by means of the familiar processes used on a large industrial scale, for example those explained above in connection with the production of isoheptene mixtures, for example by means of heterogeneous, Brønsted-acid catalysts such as those used in the PolyGas® process or EMOGAS® process, by means of the Dimersol® process with use of nickel complex catalysts homogeneously dissolved in the reaction medium, or by means of heterogeneous, nickel(II)-oxide-containing catalysts by the Octol® process or by the process of WO 9514647. The resultant isooctene mixtures are converted to isononanal mixtures by the known processes explained above in connection with the production of heptanal isomer mixtures, by means of rhodium or cobalt-catalyzed hydroformylation, preferably cobalt-catalyzed hydroformylation. These are then hydrogenated to give the suitable isononanol mixtures, for example by means of one of the catalysts mentioned above in connection with the production of isoheptanol.

The resultant isononanol isomer mixtures can be characterized by way of their iso-index, which can be calculated from the degree of branching of the individual, isomeric isononanol components in the isononanol mixture multiplied by the percentage proportion of these in the isononanol mixture; by way of example, n-nonanol contributes the value 0 to the iso-index of an isononanol mixture, methyloctanols (single branching) contribute the value 1, and dimethylheptanols (double branching) contribute the value 2. The higher the linearity, the lower is the iso-index of the relevant isononanol mixture. Accordingly, the iso-index of an isononanol mixture can be determined via gas-chromatographic separation of the isononanol mixture into its individual isomers and attendant quantification of the percentage quantitative proportion of these in the isononanol mixture, determined by standard methods of gas-chromatographic analysis. In order to increase the volatility of the isomeric nonanols and improve the gas-chromatographic separation of these, they are advantageously trimethylsilylated by means of standard methods, for example via reaction with N-methyl-N-trimethylsilyltrifluoracetamide, prior to gas-chromatographic analysis. In order to achieve maximum quality of separation of the individual components during gas-chromatographic analysis, it is preferable to use capillary columns with polydimethylsiloxane as stationary phase. Capillary columns of this type are obtainable commercially, and a little routine experimentation by the person skilled in the art is all that is needed in order to select, from the many different products available commercially, one that has ideal suitability for this separation task.

The diisononyl esters of the general formula (II) used in the plasticizer composition of the invention have generally been esterified with isononanols with an iso index of from 0.8 to 2, preferably from 1.0 to 1.8, and particularly preferably from 1.1 to 1.5, which can be produced by the abovementioned processes.

Possible compositions of isononanol mixtures that can be used for the production of the compounds of the general formula (II) of the invention are stated below merely by way of example, and it should be noted here that the proportions of the isomers individually listed within the isononanol mixture can vary, depending on the composition of starting material, for example raffinate II, the composition of butenes in which can vary with the production process, and on variations in the production conditions used, for example the age of the catalysts utilized, and conditions of temperature and of pressure, which have to be adjusted appropriately thereto.

By way of example, an isononanol mixture produced via cobalt-catalyzed hydroformylation and subsequent hydrogenation from an isooctene mixture produced with use of raffinate II as raw material by means of the catalyst and process in accordance with WO 9514647 can have the following composition:
from 1.73 to 3.73% by weight, preferably from 1.93 to 3.53% by weight, particularly preferably from 2.23 to 3.23% by weight of 3-ethyl-6-methyl-hexanol;
from 0.38 to 1.38% by weight, preferably from 0.48 to 1.28% by weight, particularly preferably from 0.58 to 1.18% by weight of 2,6-dimethylheptanol;
from 2.78 to 4.78% by weight, preferably from 2.98 to 4.58% by weight, particularly preferably from 3.28 to 4.28% by weight of 3,5-dimethylheptanol;
from 6.30 to 16.30% by weight, preferably from 7.30 to 15.30% by weight, particularly preferably from 8.30 to 14.30% by weight of 3,6-dimethylheptanol;
from 5.74 to 11.74% by weight, preferably from 6.24 to 11.24% by weight, particularly preferably from 6.74 to 10.74% by weight of 4,6-dimethylheptanol;
from 1.64 to 3.64% by weight, preferably from 1.84 to 3.44% by weight, particularly preferably from 2.14 to 3.14% by weight of 3,4,5-trimethylhexanol;
from 1.47 to 5.47% by weight, preferably from 1.97 to 4.97% by weight, particularly preferably from 2.47 to 4.47% by weight of 3,4,5-trimethylhexanol, 3-methyl-4-ethylhexanol and 3-ethyl-4-methylhexanol;
from 4.00 to 10.00% by weight, preferably from 4.50 to 9.50% by weight, particularly preferably from 5.00 to 9.00% by weight of 3,4-dimethylheptanol;
from 0.99 to 2.99% by weight, preferably from 1.19 to 2.79% by weight, particularly preferably from 1.49 to 2.49% by weight of 4-ethyl-5-methylhexanol and 3-ethylheptanol;
from 2.45 to 8.45% by weight, preferably from 2.95 to 7.95% by weight, particularly preferably from 3.45 to 7.45% by weight of 4,5-dimethylheptanol and 3-methyloctanol;
from 1.21 to 5.21% by weight, preferably from 1.71 to 4.71% by weight, particularly preferably from 2.21 to 4.21% by weight of 4,5-dimethylheptanol;
from 1.55 to 5.55% by weight, preferably from 2.05 to 5.05% by weight, particularly preferably from 2.55 to 4.55% by weight of 5,6-dimethylheptanol;
from 1.63 to 3.63% by weight, preferably from 1.83 to 3.43% by weight, particularly preferably from 2.13 to 3.13% by weight of 4-methyloctanol;
from 0.98 to 2.98% by weight, preferably from 1.18 to 2.78% by weight, particularly preferably from 1.48 to 2.48% by weight of 5-methyloctanol; from 0.70 to 2.70% by weight, preferably from 0.90 to 2.50% by weight, particularly preferably from 1.20 to 2,20% by weight of 3,6,6-trimethylhexanol;
from 1.96 to 3.96% by weight, preferably from 2.16 to 3.76% by weight, particularly preferably from 2.46 to 3.46% by weight of 7-methyloctanol;
from 1.24 to 3.24% by weight, preferably from 1.44 to 3.04% by weight, particularly preferably from 1.74 to 2,74% by weight of 6-methyloctanol;
from 0.1 to 3% by weight, preferably from 0.2 to 2% by weight, particularly preferably from 0.3 to 1% by weight of n-nonanol;
from 25 to 35% by weight, preferably from 28 to 33% by weight, particularly preferably from 29 to 32% by weight of other alcohols having 9 and 10 carbon atoms; with the proviso that the entirety of the components mentioned gives

In accordance with what has been said above, an isononanol mixture produced via cobalt-catalyzed hydroformylation and subsequent hydrogenation with use of an isooctene mixture produced by means of the PolyGas® process or EMOGAS® process with an ethylene-containing butene mixture as raw material can vary within the range of the compositions below, depending on the composition of the raw material and variations in the reaction conditions used:
from 6.0 to 16.0% by weight, preferably from 7.0 to 15.0% by weight, particularly preferably from 8.0 to 14.0% by weight of n-nonanol;
from 12.8 to 28.8% by weight, preferably from 14.8 to 26.8% by weight, particularly preferably from 15.8 to 25.8% by weight of 6-methyloctanol;
from 12.5 to 28.8% by weight, preferably from 14.5 to 26.5% by weight, particularly preferably from 15.5 to 25.5% by weight of 4-methyloctanol;
from 3.3 to 7.3% by weight, preferably from 3.8 to 6.8% by weight, particularly preferably from 4.3 to 6.3% by weight of 2-methyloctanol;
from 5.7 to 11.7% by weight, preferably from 6.3 to 11.3% by weight, particularly preferably from 6.7 to 10.7% by weight of 3-ethylheptanol;
from 1.9 to 3.9% by weight, preferably from 2.1 to 3.7% by weight, particularly preferably from 2.4 to 3.4% by weight of 2-ethylheptanol;
from 1.7 to 3.7% by weight, preferably from 1.9 to 3.5% by weight, particularly preferably from 2.2 to 3.2% by weight of 2-propylhexanol;
from 3.2 to 9.2% by weight, preferably from 3.7 to 8.7% by weight, particularly preferably from 4.2 to 8.2% by weight of 3,5-dimethylheptanol;
from 6.0 to 16.0% by weight, preferably from 7.0 to 15.0% by weight, particularly preferably from 8.0 to 14.0% by weight of 2,5-dimethylheptanol;
from 1.8 to 3.8% by weight, preferably from 2.0 to 3.6% by weight, particularly preferably from 2.3 to 3.3% by weight of 2,3-dimethylheptanol;
from 0.6 to 2.6% by weight, preferably from 0.8 to 2.4% by weight, particularly preferably from 1.1 to 2.1% by weight of 3-ethyl-4-methylhexanol;
from 2.0 to 4.0% by weight, preferably from 2.2 to 3.8% by weight, particularly preferably from 2.5 to 3.5% by weight of 2-ethyl-4-methylhexanol;
from 0.5 to 6.5% by weight, preferably from 1.5 to 6% by weight, particularly preferably from 1.5 to 5.5% by weight of other alcohols having 9 carbon atoms;

with the proviso that the entirety of the components mentioned gives 100% by weight.

Decanol

Isodecanol which is used for the synthesis of the diisodecyl esters of the general formula (II) comprised in the plasticizer composition of the invention is not a unitary chemical compound, but instead is a complex mixture of differently branched isomeric decanols.

These are generally produced via nickel- or Brønsted-acid-catalyzed trimerization of propylene, for example by the PolyGas® process or the EMOGAS® process explained above, subsequent hydroformylation of the resultant isononene isomer mixture by means of homogeneous rhodium or cobalt carbonyl catalysts, preferably by means of cobalt carbonyl catalysts, and hydrogenation of the resultant isodecanal isomer mixture, e.g. by means of the catalysts and processes mentioned above in connection with the production of C₇-C₉-alcohols (Ullmann's Encyclopedia of Industrial Chemistry; 5th edition, vol. A1, p. 293, VCH Verlagsgesellschaft GmbH, Weinheim 1985). The resultant isodecanol generally has a high degree of branching.

2-Propylheptanol used for the synthesis of the di(2-propylheptyl) esters of the general formula (II) comprised in the plasticizer composition of the invention can be pure 2-propylheptanol or can be propylheptanol isomer mixtures of the type generally formed during the industrial production of 2-propylheptanol and likewise generally termed 2-propylheptanol.

Pure 2-propylheptanol can be obtained via aldol condensation of n-valeraldehyde and subsequent hydrogenation of the resultant 2-propylheptanal, for example in accordance with U.S. Pat. No. 2,921,089. By virtue of the production process, commercially obtainable 2-propylheptanol generally comprises, alongside the main component 2-propylheptanol, one or more of the following isomers of 2-propylheptanol: 2-propyl-4-methylhexanol, 2-propyl-5-methylhexanol, 2-isopropylheptanol, 2-isopropyl-4-methyl-hexanol, 2-isopropyl-5-methylhexanol, and/or 2-propyl-4,4-dimethylpentanol. The presence of other isomers of 2-propylheptanol, for example 2-ethyl-2,4-dimethyl-hexanol, 2-ethyl-2-methylheptanol, and/or 2-ethyl-2,5-dimethylhexanol, in the 2-propyl-heptanol is possible, but because the rates of formation of the aldehydic precursors of these isomers in the aldol condensation are low, the amounts of these present in the 2-propylheptanol are only trace amounts, if they are present at all, and they play practically no part in determining the plasticizer properties of the compounds produced from these 2-propylheptanol isomer mixtures.

Various hydrocarbon sources can be utilized as starting material for the production of 2-propylheptanol, for example 1-butene, 2-butene, raffinate I—an alkane/alkene mixture which is obtained from the C₄-cut of a cracker after removal of allenes, of acetylenes, and of dienes and which also comprises, alongside 1- and 2-butene, considerable amounts of isobutene—or raffinate II, which is obtained from raffinate I via removal of isobutene and then comprises, as olefin components other than 1- and 2-butene, only small proportions of isobutene. It is also possible, of course, to use mixtures of raffinate I and raffinate II as raw material for the production of 2-propylheptanol. These olefins or olefin mixtures can be hydroformylated by methods that are conventional per se with cobalt or rhodium catalysts, and 1-butene here gives a mixture of n- and isovaleraldehyde—the term isovaleraldehyde designating the compound 2-methylbutanal, the n/iso ratio of which can vary within relatively wide limits, depending on catalyst used and on hydroformylation conditions. By way of example, when a triphenylphosphine-modified homogeneous rhodium catalyst (Rh/TPP) is used, n- and isovaleraldehyde are formed in an n/iso ratio that is generally from 10:1 to 20:1 from 1-butene, whereas when rhodium hydroformylation catalysts modified with phosphite ligands are used, for example in accordance with U.S. Pat. No. 5,288,918 or WO 05028407, or when rhodium hydroformylation catalysts modified with phosphoamidite ligands are used, for example in accordance with WO 0283695, n-valeraldehyde is formed almost exclusively. While the Rh/TPP catalyst system converts 2-butene only very slowly in the hydroformylation, and most of the 2-butene can therefore be reclaimed from the hydroformylation mixture, 2-butene is successfully hydroformylated with the phosphite-ligand- or phosphorus amidite ligand-modified rhodium catalysts mentioned, the main product formed being n-valeraldehyde. In contrast, isobutene comprised within the olefinic raw material is hydroformylated at varying rates by practically all catalyst systems to 3-methylbutanal and, in the case of some catalysts, to a lesser extent to pivalaldehyde.

The C₅-aldehydes obtained in accordance with starting materials and catalysts used, i.e. n-valeraldehyde optionally mixed with isovaleraldehyde, 3-methylbutanal, and/or pivalaldehyde, can be separated, if desired, completely or to some extent by distillation into the individual components prior to the aldol condensation, and here again there is therefore a possibility of influencing and of controlling the composition of isomers of the C₁₀-alcohol component of the ester mixtures used in the process of the invention. Equally, it is possible that the C₅-aldehyde mixture formed during the hydroformylation is introduced into the aldol condensation without prior isolation of individual isomers. If n-valeraldehyde is used in the aldol condensation, which can be carried out by means of a basic catalyst, for example an aqueous solution of sodium hydroxide or of potassium hydroxide, for example by the processes described in EP-A 366089, U.S. Pat. No. 4,426,524, or U.S. Pat. No. 5,434,313, 2-propylheptanal is produced as sole condensate, whereas if a mixture of isomeric 05-aldehydes is used the product comprises an isomer mixture of the products of the homoaldol condensation of identical aldehyde molecules and of the crossed aldol condensation of different valeraldehyde isomers. The aldol condensation can, of course, be controlled via targeted reaction of individual isomers in such a way that a single aldol condensation isomer is formed predominantly or entirely. The relevant aldol condensates can then be hydrogenated with conventional hydrogenation catalysts, for example those mentioned above for the hydrogenation of aldehydes, to give the corresponding alcohols or alcohol mixtures, usually after preceding, preferably distillative isolation from the reaction mixture and, if desired, distillative purification.

As mentioned above, the compounds of the general formula (II) comprised in the plasticizer composition of the invention can have been esterified with pure 2-propyl-heptanol. However, production of said esters generally uses mixtures of 2-propyl-heptanol with the propylheptanol isomers mentioned in which the content of 2-propylheptanol is at least 50% by weight, preferably from 60 to 98% by weight, and particularly preferably from 80 to 95% by weight, in particular from 85 to 95% by weight.

Suitable mixtures of 2-propylheptanol with the propylheptanol isomers comprise by way of example those of from 60 to 98% by weight of 2-propylheptanol, from 1 to 15% by weight of 2-propyl-4-methylhexanol, and from 0.01 to 20% by weight of 2-propyl-5-methylhexanol, and from 0.01 to 24% by weight of 2-isopropylheptanol, where the sum of the proportions of the individual constituents does not exceed 100% by weight. It is preferable that the proportions of the individual constituents give a total of 100% by weight.

Other suitable mixtures of 2-propylheptanol with the propylheptanol isomers comprise by way of example those of from 75 to 95% by weight of 2-propylheptanol, from 2 to 15% by weight of 2-propyl-4-methylhexanol, from 1 to 20% by weight of 2-propyl-5-methylhexanol, from 0.1 to 4% by weight of 2-isopropylheptanol, from 0.1 to 2% by weight of 2-isopropyl-4-methylhexanol, and from 0.1 to 2% by weight of 2-isopropyl-5-methylhexanol, where the sum of the proportions of the individual constituents does not exceed 100% by weight. It is preferable that the proportions of the individual constituents give a total of 100% by weight.

Preferred mixtures of 2-propylheptanol with the propylheptanol isomers comprise those with from 85 to 95% by weight of 2-propylheptanol, from 5 to 12% by weight of 2-propyl-4-methylhexanol, and from 0.1 to 2% by weight of 2-propyl-5-methylhexanol, and from 0.01 to 1% by weight of 2-isopropylheptanol, where the sum of the proportions of the individual constituents does not exceed 100% by weight. It is preferable that the proportions of the individual constituents give a total of 100% by weight.

When the 2-propylheptanol isomer mixtures mentioned are used instead of pure 2-propylheptanol for the production of the compounds of the general formula (II), the isomer composition of the alkyl ester groups and, respectively alkyl ether groups corresponds in practical terms to the composition of the propylheptanol isomer mixtures used for the esterification.

Undecanol

The undecanols used for the production of the compounds of the general formula (II) comprised in the plasticizer composition of the invention can be straight-chain or branched, or can be composed of mixtures of straight-chain and branched undecanols, it is preferable to use, as alcohol component, mixtures of branched undecanols, also termed isoundecanol.

Substantially straight-chain undecanol can be obtained via rhodium- or preferably cobalt-catalyzed hydroformylation of 1-decene and subsequent hydrogenation of the resultant n-undecanal. The starting olefin 1-decene is produced by way of the SHOP process mentioned previously for the production of 1-octene.

For the production of branched isoundecanol, the 1-decene obtained in the SHOP process can be subjected to skeletal isomerization, for example by means of acidic zeolitic molecular sieves, as described in WO 9823566, whereupon mixtures of isomeric decenes are formed, rhodium- or preferably cobalt-catalyzed hydroformylation of which, with subsequent hydrogenation of the resultant isoundecanal mixtures, gives the isoundecanol used for the production of the compounds (II) used in the invention. Hydroformylation of 1-decene or of isodecene mixtures by means of rhodium or cobalt catalysis can be achieved as described previously in connection with the synthesis of C₇-C₁₀-alcohols. Similar considerations apply to the hydrogenation of n-undecanal or of isoundecanal mixtures to give n-undecanol and, respectively, isoundecanol.

After distillative purification of the hydrogenation product, the resultant C₇-C₁₁-alkyl alcohols or a mixture of these can be used as described above for the production of the diester compounds of the general formula (II) used in the invention.

Dodecanol

Substantially straight-chain dodecanol can be obtained advantageously by way of the Alfol® process or Epal® process. These processes include the oxidation and hydrolysis of straight-chain trialkylaluminum compounds which are constructed stepwise by way of a plurality of ethylation reactions, starting from triethylaluminum, with use of Ziegler-Natta catalysts. The desired n-dodecanol can be obtained from the resultant mixtures of substantially straight-chain alkyl alcohols of varying chain length after distillative discharge of the C₁₂-alkyl alcohol fraction.

Alternatively, n-dodecanol can also be produced via hydrogenation of natural fatty acid methyl esters, for example from coconut oil.

Branched isododecanol can be obtained by analogy with the known processes for the codimerization and/or oligomerization of olefins, as described by way of example in WO 0063151, with subsequent hydroformylation and hydrogenation of the isoundecene mixtures, as described by way of example in DE-A 4339713. After distillative purification of the hydrogenation product, the resultant isododecanols or mixtures of these can be used as described above for the production of the diester compounds of the general formula (II) used in the invention.

Plastisol Applications

As described above, the good gelling properties of the plasticizer composition of the invention makes it particularly suitable for the production of plastisols.

The invention therefore further provides the use of a plasticizer composition as defined above as plasticizer in a plastisol.

Plastisols can be produced from various plastics. In one preferred embodiment, the plastisols of the invention are PVC plastisols.

The content of plasticizer composition of the invention in the PVC plastisols is usually from 5 to 300 phr, preferably from 50 to 200 phr.

Plastisols are usually converted to the form of the finished product at ambient temperature via various processes, such as spreading process, screenprinting process, casting processes, for example the slush molding process or rotomolding process, dip-coating process, spray process, and the like. Gelling then takes place via heating, whereupon cooling gives a homogeneous product with relatively high or relatively low flexibility.

PVC plastisols are particularly suitable for the production of PVC foils, for the production of seamless hollow bodies and of gloves, and for use in the textile sector, e.g. for textile coatings.

The PVC plastisols based on the plasticizer composition of the invention are specifically suitable for the production of synthetic leather, e.g. of synthetic leather for motor vehicle construction; underbody protection for motor vehicles; seam seals; carpet-backing coatings; high-weight coatings; conveyor belts; dip coatings, and items produced by means of dip processes; toys, such as dolls, balls, and toy animals; anatomical models for educational uses; floorcoverings; wallcoverings; (coated) textiles, for example latex apparel, protective apparel, and rainproof apparel, for example rainproof jackets; tarpaulins, for example truck tarpaulins, tenting, and roof sheeting; tents; belt coatings; sealing compositions for closures; respiratory masks, and gloves.

Molding Composition Applications

The molding composition of the invention is preferably used for the production of moldings and foils. Among these are in particular housings of electrical devices, for example of kitchen devices, and computer housings; tooling; equipment; piping; cables; hoses, for example plastics hoses, water hoses and irrigation hoses, industrial rubber hoses, or chemicals hoses; wire sheathing; window profiles; vehicle-construction components, for example bodywork constituents, vibration dampers for engines; tires; furniture, for example chairs, tables, or shelving; foam for cushions and mattresses; gaskets; composite foils, such as foils for laminated safety glass, in particular for vehicle windows and/or window panes, recording discs; packaging containers; adhesive-tape foils, or coatings.

The molding composition of the invention is also suitable for the production of moldings and foils which come directly into contact with people or with foods. These are primarily medical products, hygiene products, packaging for food or drink, products for the interior sector, toys and child-care items, sports-and-leisure products, apparel, or else fibers for textiles, and the like.

The medical products which can be produced from the molding composition of the invention are by way of example tubes for enteral nutrition and hemodialysis, breathing tubes, infusion tubes, infusion bags, blood bags, catheters, tracheal tubes, disposal syringes, gloves, or breathing masks.

The packaging that can be produced from the molding composition of the invention for food or drink is by way of example freshness-retention foils, food-or-drink hoses, drinking-water hoses, containers for storing or freezing food or drink, lid gaskets, closure caps, crown corks, or synthetic corks for wine.

The products which can be produced from the molding composition of the invention for the interior sector are by way of example ground-coverings, which can be of homogeneous structure or can be composed of a plurality of layers, for example of at least one foamed layer, examples being floorcoverings, sports floors, or luxury vinyl tiles (LVTs), synthetic leathers, wallcoverings, or foamed or unfoamed wallpapers, in buildings, or can be cladding or console covers in vehicles.

The toys and child-care items which can be produced from the molding composition of the invention are by way of example dolls, inflatable toys, such as balls, toy figures, toy animal, anatomical models for educational uses, modeling clays, swimming aids, stroller covers, baby-changing mats, bedwarmers, teething rings, or bottles.

The sports-and-leisure products that can be produced from the molding composition of the invention are by way of example gymnastics balls or other balls, exercise mats, seat cushions, massage balls and massage rolls, shoes and shoe soles, air mattresses, or drinking bottles.

The apparel that can be produced from the molding compositions of the invention is by way of example rubber boots.

Non-PVC Applications

The present invention also includes the use of the plasticizer composition of the invention as and/or in auxiliaries selected from: calendering auxiliaries; rheology auxiliaries; surfactant compositions, such as flow aids and film-forming aids, defoamers, antifoams, wetting agents, coalescing agents, and emulsifiers; lubricants, such as lubricating oils, lubricating greases, and lubricating pastes; quenchers for chemical reactions; phlegmatizing agents; pharmaceutical products; plasticizers in adhesives or sealants; impact modifiers, and antiflow additives.

The figures and examples described below provide further explanation of the invention. These figures and examples are not to be understood as restricting the invention.

The following abbreviations are used in the examples and figures below:

Hexamoll® DINCH® means diisononyl cyclohexane-1,2-dicarboxylate,

Palatinol® N means diisononyl phthalate,

Eastman™ 168 means di(2-ethylhexyl) terephthalate (DOTP),

Vestinol® INB means isononyl benzoate,

Jayflex® MB 10 means isodecyl benzoate,

phr means parts by weight per 100 parts by weight of polymer.

### DESCRIPTION OF FIGURES

FIG. 1 shows the gelling behavior of PVC plastisols with a total proportion of plasticizer or plasticizer composition of the invention that is in each case 100 phr. The complex viscosity η* [Pa·s] of the plastisols is plotted as a function of temperature [° C.]. A plasticizer composition was used here comprising the commercially obtainable plasticizer Eastman™ 168 (DOTP) and the fast fuser 2-ethylhexyl 2,5-furan-dicarboxylate in a quantitative ratio of 70:30. The gelling behavior of PVC plastisols comprising exclusively the commercially obtainable plasticizer Palatinol® N or Hexamoll® DINCH® is also plotted as comparison.

FIG. 2 shows the gelling behavior of PVC plastisols comprising, as plasticizer, specific blends of Eastman™ 168 (DOTP) with the fast fuser 2-ethylhexyl 2,5-furan-dicarboxylate and the commercially obtainable fast fuser Vestinol® INB or Jayflex® MB 10. The complex viscosity η* [Pa·s] of the plastisols is plotted as a function of temperature [° C.]. The proportion of the respective fast fuser in the plasticizer mixtures is selected in such a way that the gelling temperature of Palatinol® N is achieved. The gelling behavior of PVC plastisols comprising exclusively the commercially obtainable plasticizer Eastman™ 168 or Palatinol® N is also shown. The total plasticizer content of the plastisols is 100 phr.

FIG. 3 shows the process volatility of PVC plastisols comprising 60 phr of the plasticizer composition of the invention, and also comprising various blends of Eastman™ 168 (DOTP) with the commercially obtainable fast fusers Vestinol® INB or Jayflex® MB 10. The weight loss from the plastisols in % after a gelling time of 2 minutes at 190° C. is shown. Also shown is the process volatility of PVC plastisols comprising exclusively the commercially obtainable plasticizer Eastman™ 168 (DOTP) or Palatinol® N.

FIG. 4 shows foil volatility of PVC foils produced from plastisols comprising 60 phr of the plasticizer composition used in the invention, and also various blends of Eastman™ 168 (DOTP) with the commercially obtainable fast fuser Vestinol® INB or Jayflex® MB 10. Weight loss from the PVC foils in % after 24 h in a drying oven at 130° C. is shown. Foil volatility of PVC foils produced from plastisols comprising exclusively the commercially obtainable fast plasticizer Eastman™ 168 (DOTP) or Palatinol® N is also shown.

FIG. 5 shows the Shore A hardness of PVC foils produced from PVC plastisols comprising 60 phr of the plasticizer composition of the invention, and also various blends of Eastman™ 168 (DOTP) with the commercially obtainable fast fuser Vestinol® INB or Jayflex® MB 10. Also shown is the Shore A hardness of foils produced from PVC plastisols comprising exclusively the commercially obtainable plasticizer Eastman™ 168 (DOTP) or Palatinol® N. Shore A hardness was measured in accordance with DIN ISO 868, each of the measured values being read after 15 seconds.

FIG. 6 shows the 100% modulus (modulus of elasticity) in [MPa] of PVC foils produced from plastisols comprising 60 phr of the plasticizer composition used in the invention, and also various blends of Eastman™ 168 (DOTP) with the commercially obtainable fast fuser Vestinol® INB or Jayflex® MB 10. Also shown is the 100% modulus [MPa] of PVC foils produced from PVC plastisols comprising exclusively the commercially obtainable plasticizer Eastman™ 168 (DOTP) or Palatinol® N.

### EXAMPLES

The examples use inter alia the following starting materials:

| Starting material | Producer |
|---|---|
| Homopolymeric emulsion PVC, | SolVin SA, Brussels, Belgium |
| trademark Solvin ® 367 NC | |
| Homopolymeric emulsion PVC, | Vinnolit GmbH, Ismaning, |
| trademark Vinnolit ® P 70 | Germany |
| Diisononyl cyclohexane-1,2-dicarboxylate, | BASF SE, Ludwigshafen, |
| trademark Hexamoll ® DINCH ® | Germany |
| Isononyl benzoate, | Evonik, Marl, Germany |
| trademark Vestinol ® INB | |
| Isodecyl benzoate, | Exxonmobil Chemical |
| trademark Jayflex ® MB 10 | Belgium, Antwerp, Belgium |
| Di(2-ethylhexyl) terephthalate (DOTP), | Eastman Chemical B.V., |
| trademark Eastman ™ 168 | Capelle aan den Ijssel, The |
| | Netherlands |
| Diisononyl phthalate, | BASF SE, Ludwigshafen, |
| trademark Palatinol ® N | Germany |
| Ba—Zn stabilizer, | Reagens S.p.A., Bologna, |
| trademark Reagens ® SLX/781 | Italy |

### I) Examples of Production of Compounds (I) Used in the Invention

### Example 1

### Synthesis of di(2-ethylhexyl) 2,5-furandicarboxylate via direct esterification

782 g (6.00 mol, 4.0 equivalents) of 2-ethylhexanol were used as initial charge in 500 g of toluene in a 2 L round-necked flask equipped with a Dean-Stark water separator and a dropping funnel with pressure equalization. The mixture was heated to reflux, with stirring, and 234 g (1.50 mol, 1.0 equivalent) of 2,5-furandicarboxylic acid were added, followed by 11.5 g (0.12 mol, 8 mol %) of 99.9% by weight sulfuric acid in from 3 to 4 portions whenever the reaction slowed. The course of the reaction was monitored on the basis of the amount of water separated in the Dean-Stark apparatus. After complete conversion, a specimen was taken from the reaction mixture and analyzed by GC. The reaction mixture was cooled to room temperature, transferred to a separating funnel, and washed twice with saturated NaHCO₃ solution. The organic phase was washed with saturated sodium chloride solution and dried with anhydrous Na₂SO₄, and the solvent was removed under reduced pressure. The crude product was purified by means of fractional distillation. The desired di(2-ethylhexyl) 2,5-furandicarboxylate was obtained here in a yield of 80% and in a purity of 98.9%. The identity and purity of the final product was determined by means of NMR and GC-MS analysis (GC column: Agilent J&W DB-5, 30 m×0.32 mm×1.0 μm or Ohio Valley OV-1701 60 m×0.32 mm×0.25 μm).

### II) Performance Testing

II.a) Determination of Solvation Temperature in Accordance with DIN 53408:

To characterize the gelling performance of the compounds (I) used in the invention in PVC, the solvation temperature was determined in accordance with DIN 53408. In accordance with DIN 53408, a droplet of a slurry of 1 g of PVC in 19 g of plasticizer is observed in transmitted light under a microscope equipped with a heatable stage. The temperature here is increased linearly by 2° C. per minute, starting at 60° C. The solvation temperature is the temperature at which the PVC particles become invisible, i.e. it is no longer possible to discern their outlines and contrasts. The lower the solvation temperature, the better the gelling performance of the relevant substance for PVC.

The table below lists the solvation temperature of the di(2-ethylhexyl) 2,5-furandicarboxylate plasticizer and, as comparison, the solvation temperatures of the commercially available standard plasticizers di(2-ethylhexyl) phthalate (dioctyl phthalate, BOC Sciences, NY, US), diisononyl phthalate (Palatinol® DINP, BASF Corp, Florham Park, US) and di(2-ethylhexyl) terephthalate (Palatinol® DOTP, BASF Corp, Florham Park, US).

| | | Solvation |
|---|---|---|
| | | temperature in |
| | | accordance with |
| | | DIN 53408 |
| Ex. No. | Substance | [° C.] |
| 1 | Di(2-ethylhexyl) 2,5-furandicarboxylate | 118 |
| Comp 1 | Di(2-ethylhexyl) phthalate (dioctyl phthalate, | 126 |
| | BOC Sciences, NY, US) | |
| Comp 2 | Diisononyl phthalate (Palatinol ® DINP, | 131 |
| | BASF Corp., Florham Park, US) | |
| Comp 3 | Di(2-ethylhexyl)terephthalate (Palatinol ® | 146 |
| | DOTP, BASF Corp., Florham Park, US) | |

As can be seen from the table, di(2-ethylhexyl) 2,5-furandicarboxylate exhibits the lowest solvation temperature. At a temperature of 118° C., it lies surprisingly within the range of rapid-gelling plasticizers, i.e. below 120° C.

II.b) Determination of Gelling Behavior of PVC Plastisols Comprising the Plasticizer Composition of the Invention

The gelling behavior of PVC plastisols based on the plasticizer compositions of the invention was studied by producing PVC plastisols comprising mixtures of the commercially obtainable plasticizer Eastman™ 168 with the gelling aid di-2-ethylhexyl 2,5-furandicarboxylate in various quantitative ratios (e.g. 70/30 Eastman™ 168 to di-2-ethylhexyl 2,5-furandicarboxylate), formulated as follows:

| | Proportion |
|---|---|
| Starting material | [phr] |
| PVC (mixture of 70 parts by weight of homopolymeric | 100 |
| emulsion PVC, trademark Solvin ® 367 NC and 30 parts by | |
| weight of homopolymeric emulsion PVC, trademark | |
| Vinnolit ® P 70) | |
| Plasticizer composition of the invention | 100 |
| Ba—Zn stabilizer Reagens ® SLX/781 | 2 |

Plastisols comprising exclusively the commercially obtainable plasticizer Hexamoll® DINCH® or Palatinol® N were also produced as comparison.

The plastisols were produced by weighing the two types of PVC together in a PE (polyethylene) beaker. The liquid components were weighed into a second PE beaker. The PVC was stirred into the liquid components at 400 rpm with the aid of a dissolver (Jahnke & Kunkel, IKA-Werk, RE-166 A, 60-6000 rpm, diameter of dissolver disk=40 mm). Once the mixture had become a plastisol, rotation rate was increased to 2500 rpm and the mixture was homogenized for 150 s. The plastisol was transferred from the PE beaker into a steel dish, and this was exposed to a pressure of 10 mbar in a desiccator. The intention here was to remove the air comprised in the plastisol. The plastisol expands to an extent depending on air content. The desiccator is shaken at this stage to disrupt the surface of the plastisol and to cause it to collapse. Starting from this juncture, the plastisol is kept for a further 15 min in the desiccator at a pressure of 10 mbar. The vacuum pump is then switched off, air is introduced into the desiccator, and the plastisol is transferred back into the PE beaker. The plastisol is then ready for the rheological measurements. Measurements of all of the plastisols started 30 min after homogenization.

Gelling of a liquid PVC plastisol and conversion from the condition of PVC particles homogenously dispersed in plasticizer to a homogenous, solid flexible PVC matrix requires introduction of the necessary energy in the form of heat. Relevant parameters available during processing are temperature and residence time. The faster the gelling (indicated here by the solvation temperature: the lower this is, the more rapidly the material gels), the lower the temperature that can be selected (for an identical residence time), or the lower the residence time that can be selected (for identical temperature).

The gelling behavior of a plastisol is studied by using a MCR101 rheometer from Anton Paar. The viscosity of the paste is measured here on exposed heat at constant, low shear (oscillation). The parameters used for the oscillation tests were as follows:

| | |
|---|---|
| Measurement system: | Parallel plates, diameter 50 mm |
| Amplitude γ: | 1% |
| Frequency: | 1 Hz |
| Gap width: | 1 mm |
| Starting temperature: | 20° C. |
| Temperature profile: | 20° C.-200° C. |
| Heating rate: | 10° C./min |
| Number of measurement points: | 201 |
| Duration of measurement for each | 0.09 min |
| measurement point: | |

There were two measurement steps. The first step serves merely to adjust the temperature of the sample. The plastisol is exposed to low shear for 2 min at constant amplitude (γ=1%) at 20° C. Application of the temperature profile begins in the second step. Measurement comprises recording of storage modulus and loss modulus. The complex viscosity η* is calculated from these two variables. The temperature at which the complex viscosity reaches its maximum is termed the gelling point of the plastisol.

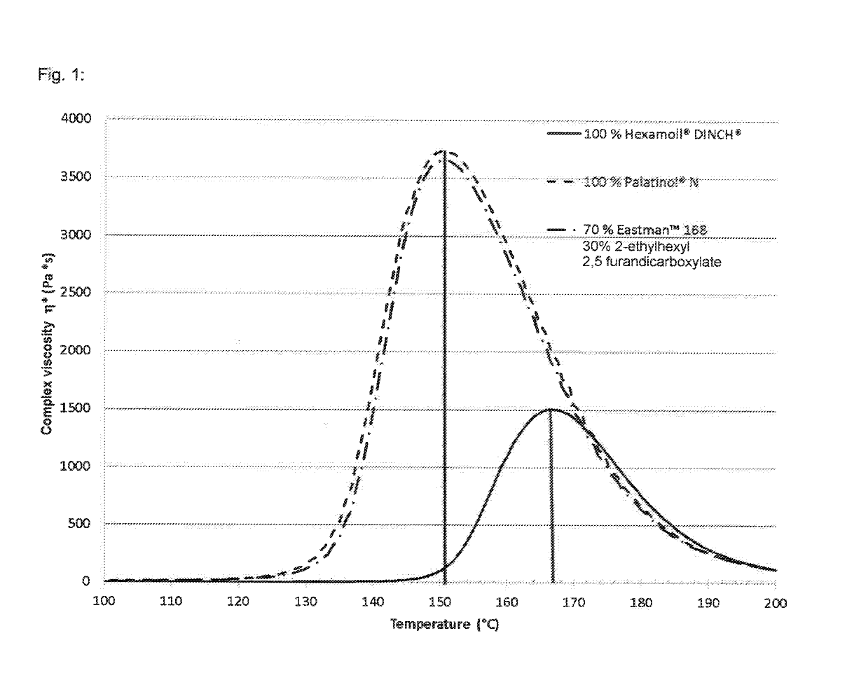

As can be very clearly seen from FIG. 1, the PVC plastisols with the plasticizer composition of the invention gel at significantly lower temperatures than the PVC plastisol comprising exclusively the commercially obtainable plasticizer Hexamoll® DINCH®. A composition of 70% of Eastman™ 168 and 30% of di-2-ethylhexyl 2,5-furandicarboxylate achieves a gelling point of 150° C., which corresponds to the gelling point of the commercially obtainable plasticizer Palatinol® N, and which is sufficient for many plastisol applications. A further significant reduction of the gelling point can be achieved via a further increase in the proportion of the gelling aid di-2-ethylhexyl 2,5-furandicarboxylate in the plasticizer compositions used in the invention.

II.c) Determination of Gelling Behavior of PVC Plastisols Comprising the Plasticizer Composition of the Invention in Comparison with PVC Plastisols Comprising Conventional Fast Fusers

The procedure for comparison of the gelling behavior of PCV plastisols comprising the plasticizer compositions of the invention with PVC plastisols comprising plasticizer compositions made of conventional fast fusers was analogous to the method described in II.b). The first stage here was to determine, for the conventional fast fusers isononyl benzoate (Vestinol® INB) and isodecyl benzoate (Jayflex® MB 10), the mixing ratio with the commercially obtainable plasticizer DOTP (Eastman™ 168) which gives a gelling point of 150° C., which corresponds to the gelling point of the commercially obtainable plasticizer Palatinol® N, and which is sufficient for many plastisol applications.

For Vestinol® INB this mixing ratio is 27% of Vestinol® INB and 73% of Eastman™ 168, and for Jayflex® MB 10 it is 36% of Jayflex® MB 10 and 64% of Eastman™ 168.

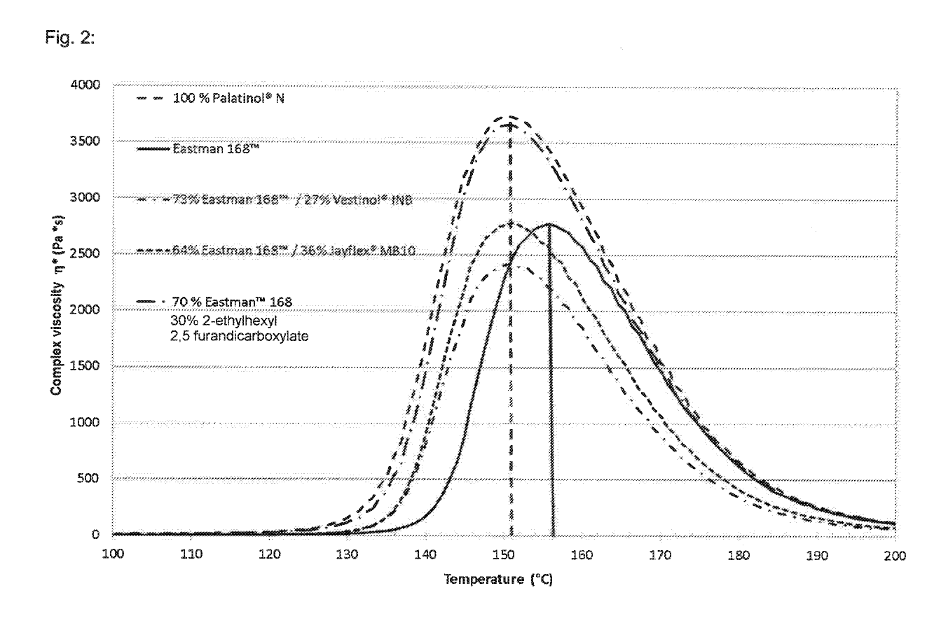

FIG. 2 collates the gelling curves of the PVC plastisols with plasticizer compositions made of the commercially obtainable fast fusers Vestinol® INB and Jayflex® MB in comparison with the gelling curves of the PVC plastisols comprising the plasticizer compositions of the invention. Also comprised as comparison are the gelling curves of the PVC plastisols comprising exclusively the commercially obtainable plasticizer Eastman™ 168 or Palatinol® N. From FIG. 2 it can be seen very clearly that in the plasticizer compositions of the invention a proportion of the fast fuser of the invention di-2-ethylhexyl 2,5-furandicarboxylate as low as 30% is sufficient to achieve a gelling point of 150° C., which corresponds to the gelling point of the commercially obtainable plasticizer Palatinol® N, and which is sufficient for many plastisol applications. In the case of the plasticizer compositions comprising the conventional fast fuser Vestinol® INB or Jayflex® MB 10, proportions of 27% of Vestinol® INB and, respectively, 36% of Jayflex® MB 10 are needed in order to achieve a gelling point of 150° C. for the plastisols. The gelling effect of the fast fuser di-2-ethylhexyl 2,5-furandicarboxylate used in the invention is accordingly at least comparable with that of the conventional fast fusers Vestinol® INB and Jayflex® MB 10.

II.d) Determination of Process Volatility of the Plasticizer Compositions of the Invention in Comparison with Plasticizer Compositions with Conventional Fast Fusers

The expression process volatility means the weight loss of plasticizer during the processing of plastisols. As described in II.c), plastisols were produced with a plasticizer composition made of 30% of the fast fuser di-2-ethylhexyl 2,5-furandicarboxylate and 70% of the commercially obtainable plasticizer Eastman™ 168 and with the plasticizer compositions made of 27% of the commercially obtainable gelling aid Vestinol® INB and 73% of the commercially obtainable plasticizer Eastman™ 168, and also 36% of the commercially obtainable fast fuser Jayflex® MB 10 and 64% of the commercially obtainable plasticizer Eastman™ 168. The formulation used was as follows.

| | Proportion |
|---|---|
| Starting material | [phr] |
| PVC (mixture of 70 parts by weight of homopolymeric | 100 |
| emulsion PVC, trademark Solvin ® 367 NC and | |
| 30 parts by weight of homopolymeric emulsion PVC, | |
| trademark Vinnolit ® P 70) | |
| Plasticizer composition | 60 |
| Ba—Zn stabilizer Reagens ® SLX/781 | 2 |

Plastisols comprising exclusively the commercially obtainable plasticizer Eastman™ 168 or Palatinol® N were also produced as comparison.

Production of a Foil Precursor

The liquid plastisol has to be converted to a processable solid foil to allow determination of the performance characteristics of the plastisols. For this, the plastisol is pre-gelled at low temperature.

The plastisols are gelled in a Mathis oven. The settings used on the Mathis oven here were as follows:

Mathis oven settings:
exhaust air: flap completely open
fresh air: open
air circulation: maximal position
upper air/lower air: upper air setting 1

Production Procedure:

A new release paper is clamped into the Mathis oven clamping apparatus. The oven is preheated to 140° C., and the gelling time is set to 25 s. The gap is set by using the thickness template to adjust the gap between paper and doctor to 0.1 mm. The dial gauge is set to 0.1 mm. The gap is then adjusted to a value of 0.7 mm on the dial gauge.

The plastisol is applied to the paper, and smoothed by the doctor. The clamping apparatus is then moved into the oven by operating the start button. After 25 s the clamping apparatus is moved back out of the oven. The plastisol has gelled, and the resultant foil can immediately be peeled in one piece from the paper. The thickness of this foil is about 0.5 mm.

Determination of Process Volatility

Process volatility is determined by using a metal Shore-Hardness punch to punch in each case 3 square test samples (49×49 mm) from the foil precursor, weighing the same, and then gelling the same for 2 minutes at 190° C. in the Mathis oven. The weight of these test samples is again measured after cooling, and weight loss in % is calculated. The test samples here were always positioned exactly at the same location on the release paper.

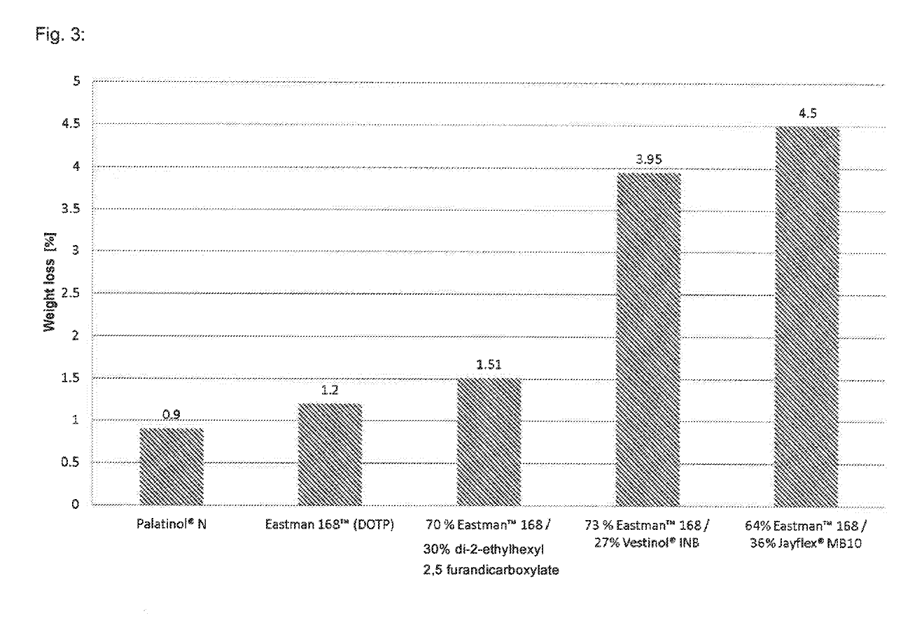

As can be seen very clearly from FIG. 3, the process volatility of the plasticizer composition of the invention made of 30% of the fast fuser di-2-ethylhexyl 2,5-furandicarboxylate and 70% of the commercially obtainable plasticizer Eastman™ 168 is markedly lower than the process volatility of the plasticizer compositions made of 27% of Vestinol® INB and 73% of Eastman™ 168, and also 36% of Jayflex® MB 10 and 64% of Eastman™ 168. Significantly less plasticizer is therefore lost during the processing of the plastisols based on the plasticizer compositions used in the invention.

However, the process volatility of the plasticizer composition of the invention made of 30% of di-2-ethylyhexyl 2,5-furandicarboxylate and 70% of Eastman™ 168 is somewhat higher than that of the pure plasticizer Eastman™ 168 or Palatinol® N.

II.e) Determination of Foil Volatility from Foils of Plastisols Comprising the Plasticizer Compositions of the Invention in Comparison with Foils Produced from Plastisols Comprising Plasticizer Compositions with Conventional Fast Fusers

Foil volatility is a measure of the volatility of a plasticizer in the finished plasticized PVC item. Foil volatility was tested by producing, as described in II.d), plastisols comprising the plasticizer composition of the invention made of 30% of di-2-ethylhexyl 2,5-furandicarboxylate and 70% of Eastman™ 168, and plastisols with plasticizer compositions made of 27% of commercially obtainable Vestinol® INB and 73% of Eastman™ 168, and also 36% of Jayflex® MB 10 and 64% of Eastman™ 168. Plastisols comprising exclusively the commercially obtainable plasticizer Eastman™ 168 or Palatinol® N were also produced as comparison. However, the first stage for the tests here was not production of a foil precursor, but instead the plastisol was directly gelled for 2 min at 190° C. in the Mathis oven. The foil volatility test was carried out on the resultant foils with a thickness of about 0.5 mm.

Foil Volatility Test Over 24 h at 130° C.:

Foil volatility was determined by cutting four individual foils (150×100 mm) from the plastisols gelled at 190° C. for 2 min, and perforating and weighing these. The foils are suspended on a rotating light-refracting element in a Heraeus 5042 E drying oven set at 130° C. The air in the oven is changed 18 times per hour. This corresponds to 800 I/h of fresh air. After 24 h in the oven, the foils are removed and again weighed. The weight loss in percent gives the foil volatility of the plasticizer compositions.

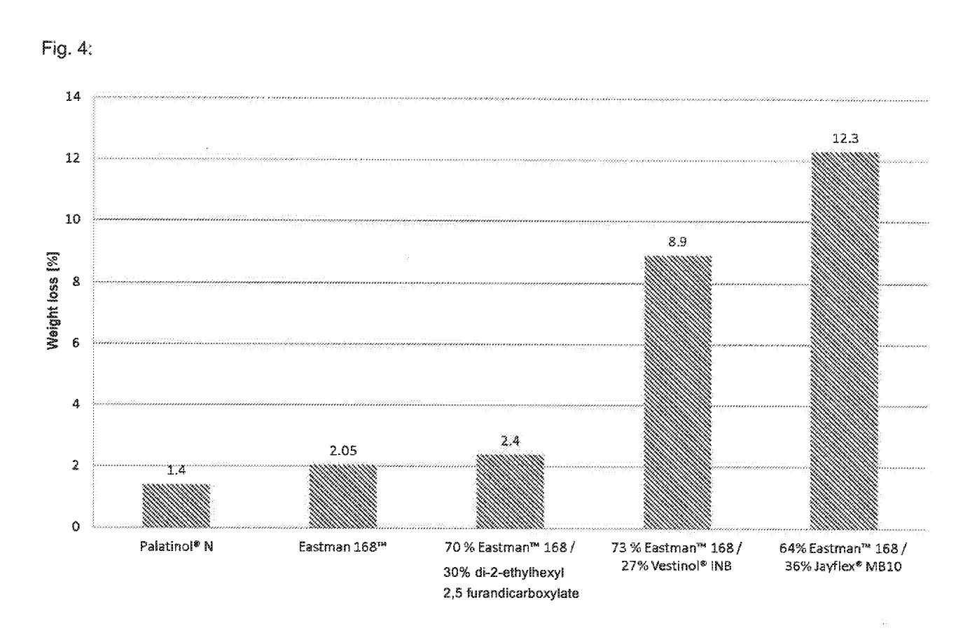

As can be seen very clearly from FIG. 4, the foil volatility of the plasticizer composition of the invention made of 30% of di-2-ethylhexyl 2,5-furandicarboxylate and 70% of Eastman™ 168, is significantly lower than the foil volatility of the plasticizer compositions made of 27% of Vestinol® INB and 73% of Eastman™ 168, and also 36% of Jayflex® MB 10 and 64% of Eastman™ 168. In the case of PVC foils comprising the plasticizer compositions of the invention, the quantity of plasticizer escaping in the finished plasticized PVC item is significantly smaller, i.e. smaller by a factor of from 3.5 and, respectively, 5.

However, the foil volatility of the plasticizer composition of the invention made of 30% of di-2-ethylyexyl 2,5-furandicarboxylate and 70% of Eastman™ 168 is somewhat higher than that of the pure plasticizer Eastman™ 168 or Palatinol® N.

II.f) Determination of Shore a Hardness from Foils of Plastisols Comprising the Plasticizer Composition of the Invention in Comparison with Foils Produced from Plastisols Comprising Plasticizer Compositions with Conventional Fast Fusers

Shore A hardness is a measure of the resilience of plasticized PVC items. Shore hardness decreases as the resilience of the PVC items increases. Shore A hardness was determined by, as described in II.d), punching foil pieces of dimensions 49×49 mm out of the foil precursors and, analogously with the volatility test, gelling at 190° C. for 2 min in each case in groups of three. A total of 27 pieces of foil were gelled in this way. These 27 pieces were mutually superposed in a press frame and pressed at 195° C. to give a Shore block of thickness 10 mm.

Description of Shore Hardness Measurement:
method: DIN EN ISO 868, October 2003,
title: Determination of indentation hardness by means of a durometer (Shore hardness),
apparatus: Hildebrand DD-3 digital durometer,
Test samples:
   dimensions: 49 mm×49 mm×10 mm (lengths×width×thickness)
   production: pressed from about 27 gel foils of thickness 0.5 mm,
   press temperature: 195° C.=5° C. above the production of the gel foils.
storage time prior to measurement: 7 d in climate chamber under controlled conditions at 23° C. and 50% rel. humidity,
measurement time: 15 s (time for which needle remains on the test sample before the value is read),
10 individual values are measured and the average value is calculated therefrom.

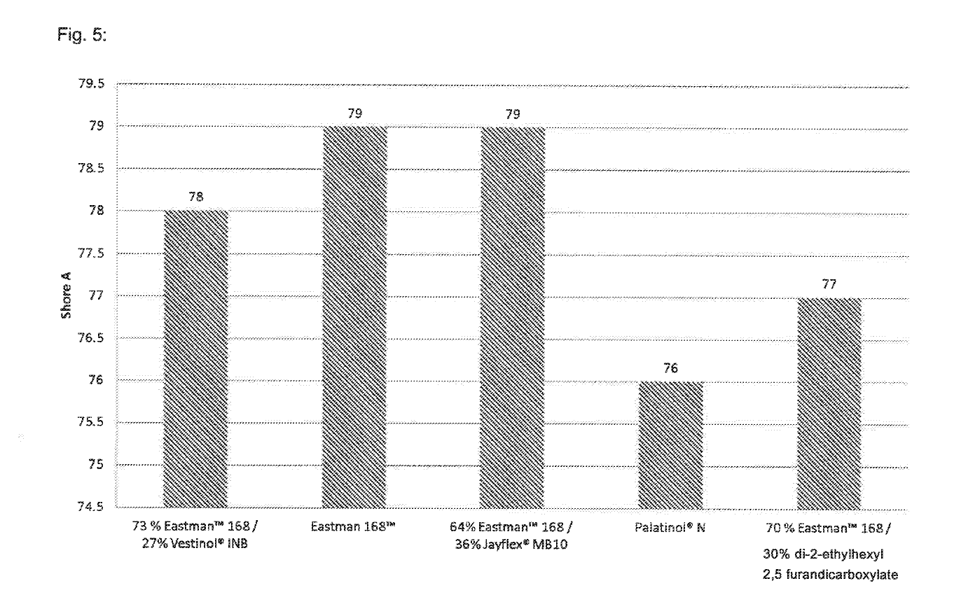

As can be seen very clearly from FIG. 5, the Shore A hardness of the foil made of the plastisol with the plasticizer composition made of 30% of di-2-ethylhexyl 2,5-furandicarboxylate and 70% of Eastman™ 168 is markedly lower than the Shore A hardness of the foils made of the plastisols with the plasticizer compositions made of 27% of Vestinol® INB and 73% of Eastman™ 168, and also 36% of Jayflex® MB and 64% of Eastman™ 168. The inventive use of plasticizer compositions comprising di-2-ethylhexyl 2,5-furandicarboxylate and Eastman™ 168 therefore leads to higher resilience of the PVC items.

The Shore A hardness of the foil made of the plastisol with the plasticizer composition made of 30% of di-2-ethylhexyl 2,5-furandicarboxylate and 70% of Eastman™ 168 is moreover also lower than the Shore A hardness of the foil made of the plastisol of the pure plasticizer Eastman™ 168, and only somewhat higher than the Shore A hardness of the foil made of the plastisol with the pure plasticizer Palatinol® N.

II.g) Determination of 100% Modulus from Foils of Plastisols Comprising the Plasticizer Compositions Used in the Invention in Comparison with Foils Produced from Plastisols Comprising Plasticizer Compositions Made of Commercially Obtainable Gelling Aids:

The mechanical properties of plasticized PVC items are characterized by way of example with the aid of the parameter 100% modulus (modulus of elasticity). As the value for the 100% modulus decreases, the mechanical properties of the plasticized PVC item improve. Lower values of the 100% modulus indicate more efficient action of the plasticizer. 100% modulus was tested by producing, as described in II.d), plastisols with a plasticizer composition made of 30% of di-2-ethylhexyl 2,5-furandicarboxylate and 70% of Eastman™ 168 and plastisols with the plasticizer compositions made of 27% of Vestinol® INB and 73% of Eastman™ 168, and also 36% of Jayflex® MB 10 and 64% of Eastman™ 168. Plastisols comprising exclusively the commercially obtainable plasticizer Eastman™ 168 or Palatinol® N were also produced as comparison. However, the first stage for the tests here was not production of a foil precursor, but instead the plastisol was directly gelled for 2 min at 190° C. in a Mathis oven. The 100% modulus test was carried out on the resultant foils with a thickness of about 0.5 mm.

The parameter 100% modulus (modulus of elasticity) was determined in accordance with DIN EN ISO 527, parts 1 and 3. The detailed procedure is as follows.
machine: Zwick TMZ 2.5/TH1S,
method: test in accordance with DIN EN ISO 527 part 1 and part 3,
test sample: type 2 punched-out foil strip in accordance with DIN EN ISO 527 part 3, 150 mm length, width 15 mm,
number of test samples: each test tests 10 samples,
controlled conditions: standard controlled conditions of 23° C. (+−1° C.), 50% relative humidity,
storage time for test samples prior to measurement: 7 days under standard conditions,
clamps: smooth, convex, clamp pressure 6 bar,
clamp length: 100 mm,
measured length (=clamp length): 100 mm,
test velocity: 100 mm/min.

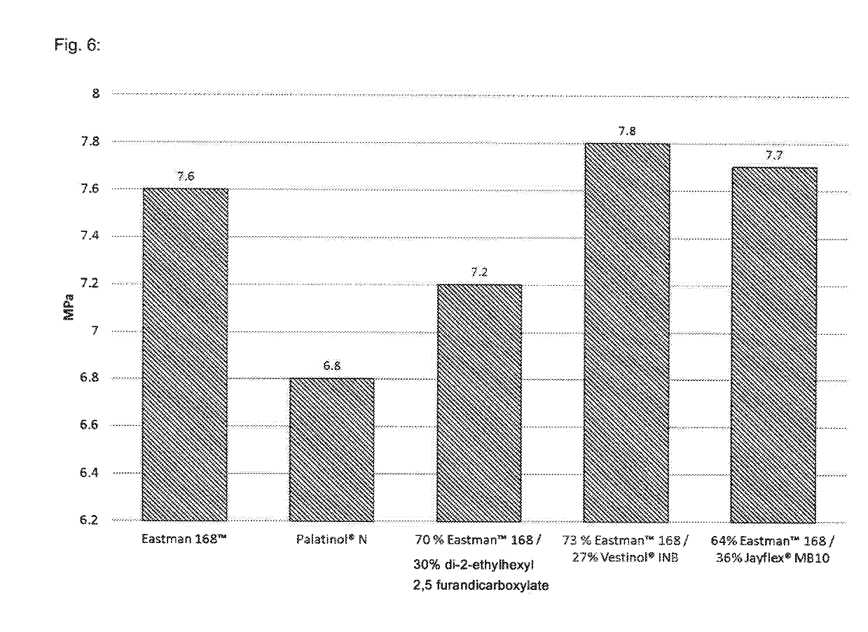

As can be seen very clearly from FIG. 6, the 100% modulus value for the foil produced from the plastisol with the plasticizer composition made of 30% of di-2-ethylhexyl 2,5-furandicarboxylate and 70% of Eastman™ 168 is significantly lower than the values for the foils produced from the plastisols with the plasticizer compositions made of 27% of Vestinol® INB and 73% of Eastman™ 168, and 36% of Jayflex® MB 10 and 64% of Eastman™ 168. The value is likewise lower than the value for foils produced from plastisols exclusively comprising the pure plasticizer Eastman™ 168, but said value is higher than the value for foils produced from plastisols comprising exclusively the pure plasticizer Palatinol® N.

1.-22. (canceled)

23. A plasticizer composition comprising
a) at least one compound of formula (I), 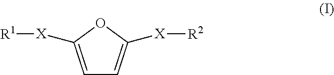
in which
X is *—(C═O)—O—, *—(CH₂)ₙ—O—, or *—(CH₂)ₙ—O—(C═O)—, where * represents the point of linkage to the furan ring, and n has the value 0, 1, or 2;
and
R¹ and R² are mutually independently an unbranched or branched C₈-alkyl moiety, and
b) at least one compound of formula (II), 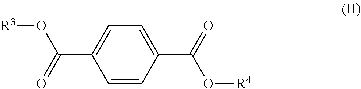
in which
R³ and R⁴ are selected mutually independently from branched and unbranched C₄-C₁₂-alkyl moieties.

24. The plasticizer composition according to claim 23, where R¹ and R² in the at least one compound of formula (I) are mutually independently n-octyl, isooctyl or 2-ethylhexyl.

25. The plasticizer composition according to claim 23, where both of R¹ and R² in the at least one compound of formula (I) are 2-ethylhexyl.

26. The plasticizer composition according to claim 23, where both of the groups X in the at least one compound formula (I) are *—(C═O)—O—.

27. The plasticizer composition according to claim 23, where both of R³ and R⁴ in the at least one compound of formula (II) are 2-ethylhexyl or both are isononyl, or both are 2-propylheptyl.

28. The plasticizer composition according to claim 23, where the plasticizer composition further comprises another plasticizer which differs from the compounds (I) and (II) and which is selected from the group consisting of dialkyl phthalates, alkyl aralkyl phthalates, dialkyl cyclohexane-1,2-dicarboxylates, trialkyl trimellitates, alkyl benzoates, dibenzoic esters of glycols, hydroxybenzoic esters, esters of saturated mono- and dicarboxylic acids, esters of unsaturated dicarboxylic acids, amides and esters of aromatic sulfonic acids, alkylsulfonic esters, glycerol esters, isosorbide esters, phosphoric esters, citric triesters, alkylpyrrolidone derivatives, 2,5-furandicarboxylic esters which differ from compounds (I), 2,5-tetrahydro-furandicarboxylic esters, epoxidized vegetable oils and epoxidized fatty acid monoalkyl esters, polyesters made of aliphatic and/or aromatic polycarboxylic acids with at least dihydric alcohols, and combinations thereof.

29. The plasticizer composition according to claim 23, where the content of the at least one compound of formula (I) in the plasticizer composition is from 1 to 50% by weight.

30. The plasticizer composition according to claim 23, where the content of the at least one compound of formula (II) in the plasticizer composition is from 10 to 99% by weight.

31. The plasticizer composition according to claim 23, where the ratio by weight of the at least one compound of formula (I) to the at least one compound of formula (II) is in the range from 1:100 to 1:1.

32. A molding composition comprising at least one polymer and one plasticizer composition according to claim 23.

33. The molding composition according to claim 32, where the polymer is a thermoplastic polymer selected from the group consisting of:
homo- and copolymers which comprise at least one copolymerized monomer selected from C₂-C₁₀-monoolefins, 1,3-butadiene, 2-chloro-1,3-butadiene, vinyl alcohol and its C₂-C₁₀-alkyl esters, vinyl chloride, vinylidene chloride, vinylidene fluoride, tetrafluoroethylene, glycidyl acrylate, glycidyl methacrylate, acrylates and methacrylates of C₁-C₁₀-alcohols, vinylaromatics, (meth)acrylonitrile, maleic anhydride, and α,β-ethylenically unsaturated mono- and dicarboxylic acids,
homo- and copolymers of vinyl acetals,
polyvinyl esters,
polycarbonates,
polyesters,
polyethers,
polyether ketones,
thermoplastic polyurethanes,
polysulfides,
polysulfones,
polyether sulfones,
cellulose alkyl esters,
and mixtures thereof.

34. The molding composition according to claim 33, where the thermoplastic polymer is selected from the group consisting of polyvinyl chloride (PVC), polyvinyl butyral (PVB), homo- and copolymers of vinyl acetate, homo- and copolymers of styrene, polyacrylates, thermoplastic polyurethanes (TPU), and polysulfides.

35. The molding composition according to claim 33, where the thermoplastic polymer is polyvinyl chloride (PVC).

36. The molding composition according to claim 35, where the content of the plasticizer composition in the molding composition is from 1.0 to 300 phr.

37. The molding composition according to claim 33, comprising at least one thermoplastic polymer which differs from polyvinyl chloride, where the content of the plasticizer composition in the molding composition is from 0.5 to 300 phr.

38. The molding composition according to claim 32, where the polymer is an elastomer selected from the group consisting of natural rubbers, synthetic rubbers, and mixtures thereof.

39. The molding composition according to claim 38, where the content of the plasticizer composition in the molding composition is from 1.0 to 60 phr.

40. The use of a plasticizer composition as defined in claim 23 as plasticizer for thermoplastic polymers and elastomers.

41. The use of a plasticizer composition as defined in claim 23 as plasticizer in a plastisol.

42. The use of a molding composition as defined in claim 32 for the production of moldings and foils, for example housings of electrical devices, computer housings, tooling, piping, cables, hoses, wire sheathing, window profiles, vehicle-construction components, tires, furniture, cushion foam and mattress foam, tarpaulins, gaskets, composite foils, recording discs, synthetic leather, packaging containers, adhesive-tape foils, or coatings.

43. The use of a molding composition as defined in claim 32 for the production of moldings and foils which come directly into contact with people or with foods.

44. The use as defined in claim 43, where the moldings and foils which come directly into contact with people or foods are medical products, hygiene products, packaging for food or drink, products for the interior sector, toys and child-care items, sports-and-leisure products, apparel, or fibers for textiles.
